(19) United States
(12) Patent Application Publication
(10) Pub. No.: US 2006/0033853 A1
(43) Pub. Date: Feb. 16, 2006

(54) Array substrate, method of manufacturing the same, color filter substrate and display device

(76) Inventors: Jae-Young Lee, Seoul (KR); Kee-Han Uh, Yongin-si (KR); Won-Sang Park, Yongin-si (KR); Sang-Woo Kim, Suwon-si (KR); Jae-Ik Lim, Chuncheon-si (KR); Irina Poundaleva, Yongin-si (KR); Sung-Eun Cha, Geoje-si (KR); Seung-Kyu Lee, Yongin-si (KR); Jae-Hyun Kim, Suwon-si (KR); Hae-Young Yun, Suwon-si (KR)

Correspondence Address: DLA PIPER RUDNICK GRAY CARY US, LLP, 2000 UNIVERSITY AVENUE, E. PALO ALTO, CA, 94303-2248, US

(21) Appl. No.: 11/202,803

(22) Filed: Aug. 11, 2005

(30) Foreign Application Priority Data
Aug. 13, 2004 (KR) 10-2004-64062
Oct. 8, 2004 (KR) 10-2004-80555

(51) Int. Cl. G02F 1/136

(52) U.S. Cl. 349/42

(57) ABSTRACT

In an array substrate, a method of manufacturing the same, a color filter substrate and a display device, the array substrate includes a switching element formed in a pixel region and a pixel electrode member electrically connected to the switching element. The pixel electrode member has a plurality of patterned openings that extend in different directions from each other in the pixel region. The color filter substrate includes a common electrode member having a recess formed in a region partially corresponding to the pixel region so as to define a plurality of domains of liquid crystal. With the multiple domains, a viewing angle of the display device is increased to improve an image display quality.

### CROSS-REFERENCE TO RELATED APPLICATIONS

This application relies for priority upon Korean Patent Application No. 2004-64062 filed on Aug. 13, 2004 and Korean Patent Application No. 2004-80555 filed on Oct. 8, 2004, the contents of which are herein incorporated by reference in their entirety.

### BACKGROUND OF THE INVENTION

1. Field of the Invention

The present invention relates to an array substrate, a method of manufacturing the same, a color filter substrate and a display device. More particularly, the present invention relates to an array substrate capable of forming a multi-domain, a method of manufacturing the array substrate, a color filter substrate and a display device.

2. Description of the Related Art

In general, a liquid crystal display (LCD) device includes an array substrate, a color filter substrate and a liquid crystal layer. The array substrate has a thin film transistor (TFT) switching a pixel, and the color filter substrate has a common electrode. The liquid crystal layer is formed between the array substrate and the color filter substrate. The LCD device displays an image using the liquid crystal layer that controls transmittance of light that passes through the liquid crystal layer in response to a voltage applied to the liquid crystal layer.

Since the LCD device displays an image using light passing through the liquid crystal layer, the LCD device has a viewing angle narrower than other types of display devices. Recently, in order to improve the viewing angle, vertically alignment (VA) mode has been developed for LCD devices.

An LCD device operating in VA mode includes two substrates that face each other and a liquid crystal layer disposed between the two substrates. The liquid crystal layer includes a plurality of liquid crystal molecules having a negative type dielectric constant anisotropy. Therefore, the liquid crystal molecules of the liquid crystal layer are homeotropically aligned.

In the VA mode, when a voltage is not applied to the liquid crystal layer, the liquid crystal molecules of the liquid crystal layer are aligned perpendicularly with respect to a surface of the substrate. Therefore, the LCD device displays a black image. When a white voltage is applied to the liquid crystal layer, the liquid crystal molecules are aligned parallel to the surface of the substrate. Therefore, the LCD device displays a white image. When a voltage having a voltage level lower than the white voltage is applied to the liquid crystal layer, the liquid crystal molecules are aligned at an angle with respect to the surface of the substrate. With this angled alignment, the LCD device displays an image having gray scales.

An LCD device operating in patterned vertical alignment (PVA) mode includes a color filter substrate having a patterned common electrode member and an array substrate having a patterned pixel electrode member.

Small-screen LCD device and medium-screen LCD device are disadvantageous in that the LCD device has a narrower viewing angle or a gray scale inversion. In order to solve compensate for these disadvantages, the small-screen and medium-screen LCD devices are often made to operate in the PVA mode.

The small-screen and medium-screen LCD devices having the PVA mode are manufactured through a process of patterning indium tin oxide that is formed on the array substrate and the color filter substrate. In particular, the color filter substrate is manufactured through a photolithography process, a developing process, an etching process and a stripping process. To align the liquid crystal molecules, an alignment layer is used with a well-known rubbing process. This alignment process can be difficult especially for small-screen and medium-screen LCD devices. A method for aligning the liquid crystal molecules without using the rubbing process is desired.

### SUMMARY OF THE INVENTION

The present invention provides an array substrate capable of forming multiple domains.

The present invention also provides a method suitable for manufacturing the above-mentioned array substrate.

The present invention also provides a color filter substrate capable of forming multiple domains.

The present invention also provides a display device capable of forming multiple domains.

In one aspect of the present invention, an array substrate includes a substrate having a pixel region, a switching element formed in the pixel region, and a pixel electrode member electrically connected to the switching element. The pixel electrode member has a plurality of patterned openings that extend in different directions from each other.

In a method of manufacturing an array substrate according to another aspect of the present invention, a gate line, a source line and a switching element electrically connected to the gate and source lines are formed in a unit pixel region of a substrate. A pixel electrode member is electrically connected to the switching element. The pixel electrode member has a plurality of patterned openings that extend in different directions from each other so as to define a plurality of multi-domains in the unit pixel region.

In still another aspect of the present invention, a color filter substrate is combined with an array substrate having a plurality of pixel electrodes. A liquid crystal layer is sandwiched between the color filter substrate and the array substrate. The color filter substrate includes a base substrate having a pixel region and a common electrode member formed on the base substrate. The common electrode member has a recess formed in the pixel region so as to form a plurality of domains in the liquid crystal layer corresponding to the pixel region.

In further still another aspect of the present invention, a display device includes an upper substrate having a common electrode member, a liquid crystal layer and a lower substrate combined with the upper substrate. The liquid crystal layer is interposed between the upper substrate and the lower substrate. The lower substrate includes a pixel electrode member facing the common electrode member. The pixel electrode member has a plurality of patterned openings that extend in different directions from each other so as to form a plurality of domains.

According to the above, the pixel electrode member of the array substrate has a protrusion, and the common electrode member of the color filter substrate has a recess, thereby forming a plurality of domains of the liquid crystal layer.

### BRIEF DESCRIPTION OF THE DRAWINGS

The above and other advantages of the present invention will become readily apparent by reference to the following detailed description when considered in conjunction with the accompanying drawings wherein:

FIG. 1 is a plan view showing a liquid crystal display (LCD) device in accordance with one embodiment of the present invention;

FIG. 2 is a cross-sectional view taken along a line I-I′ shown in FIG. 1;

FIGS. 3A and 3B are cross-sectional views showing an operation of an LCD panel of the LCD device shown in FIG. 1;

FIGS. 4A to 4D are plan views showing a method of manufacturing an array substrate of the LCD device shown in FIG. 1;

FIG. 5A is a cross-sectional view showing an operation of the LCD device shown in FIG. 1;

FIG. 5B is a graph showing a voltage applied to a liquid crystal layer of the LCD device shown in FIG. 1;

FIG. 6 is a plan view showing an array substrate in accordance with another embodiment of the present invention;

FIG. 7 is a cross-sectional view taken along a line II-II′ shown in FIG. 6;

FIGS. 8A to 8D are cross-sectional views showing a method of manufacturing the array substrate shown in FIG. 6;

FIG. 9A is a cross-sectional view showing an operation of an LCD device having the array substrate shown in FIG. 6;

FIG. 9B is a graph showing a voltage applied to a liquid crystal layer of the LCD device having the array substrate shown in FIG. 6;

FIG. 10 is a plan view showing an array substrate in accordance with another embodiment of the present invention;

FIG. 11 is a cross-sectional view taken along a line III-III′ shown in FIG. 10;

FIG. 12 is a cross-sectional view showing an LCD device in accordance with another embodiment;

FIGS. 13A to 13F are plan views showing a method of manufacturing an array substrate shown in FIG. 10;

FIG. 14 is a plan view showing an array substrate in accordance with another embodiment of the present invention;

FIG. 15 is a plan view showing an array substrate in accordance with another embodiment of the present invention;

FIG. 16 is a plan view showing an array substrate in accordance with another embodiment of the present invention;

FIG. 17 is a plan view showing an array substrate in accordance with another embodiment of the present invention;

FIG. 18 is a plan view showing an LCD device in accordance with another embodiment of the present invention;

FIG. 19 is a cross-sectional view taken along a line IV-IV′ shown in FIG. 18;

FIG. 20 is a cross-sectional view showing an operation of the LCD device shown in FIG. 18;

FIG. 21 is a plan view showing an LCD device in accordance with another embodiment of the present invention;

FIG. 22 is a cross-sectional view taken along a line V-V′ shown in FIG. 21;

FIG. 23 is a cross-sectional view showing an operation of the LCD device shown in FIG. 21;

FIG. 24 is a plan view showing an LCD device in accordance with another embodiment of the present invention;

FIG. 25 is a cross-sectional view taken along a line VI-VI′ shown in FIG. 24;

FIG. 26 is a cross-sectional view showing an operation of the LCD device shown in FIG. 24;

FIG. 27 is a plan view showing an LCD device in accordance with another embodiment of the present invention;

FIG. 28 is a cross-sectional view taken along a line VII-VII′ shown in FIG. 27; and

FIG. 29 is a cross-sectional view showing an operation of the LCD device shown in FIG. 27.

### DESCRIPTION OF THE EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

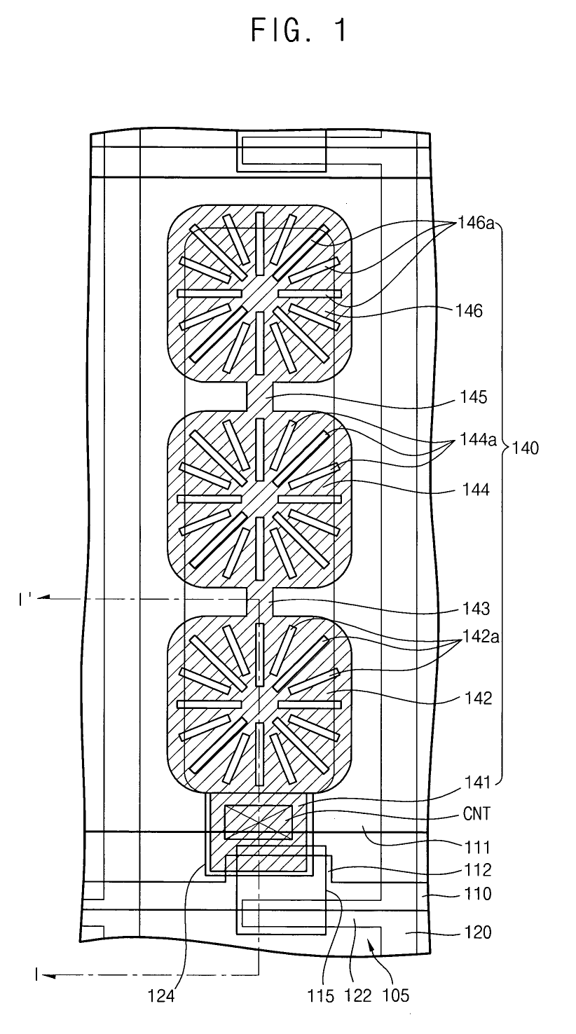

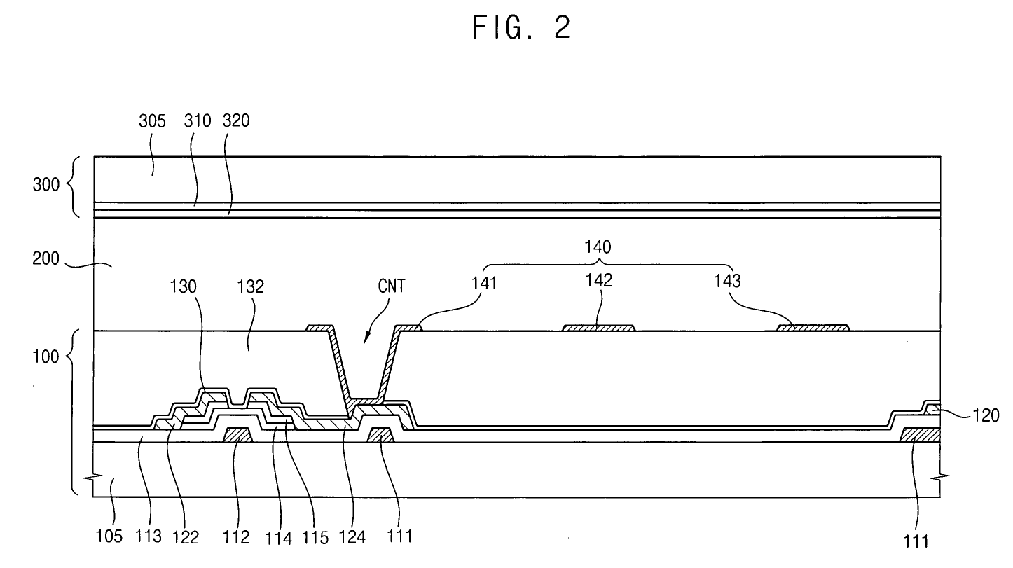

FIG. 1 is a plan view showing a liquid crystal display (LCD) device in accordance with one embodiment of the present invention. FIG. 2 is a cross-sectional view taken along a line I-I′ shown in FIG. 1. In particular, the LCD device has a transmissive typed array substrate.

Referring to FIGS. 1 and 2, the LCD device includes an array substrate 100, a liquid crystal layer 200 and a color filter substrate 300. The color filter substrate 300 is combined with the array substrate 100 so that the liquid crystal layer 200 is interposed between the color filter substrate 300 and the array substrate 100.

The array substrate 100 includes a second transparent substrate 105, a plurality of gate lines 110, a plurality of gate electrodes 112, a lower storage pattern 111 and a gate insulating layer 113. The gate lines 110 are on the second transparent substrate 105 and extend in a first direction as shown in FIG. 1. The gate electrodes 112 are electrically connected to the gate lines 110. Each of the lower storage patterns 111 is spaced apart from each of the gate lines 110 in each of unit pixel regions. The gate insulating layer 113 includes an insulating material to cover the gate lines 110 and the gate electrodes 112. Examples of the insulating material that can be used for the gate insulating layer 113 include silicon nitride, silicon oxide, etc.

The array substrate 100 may further include a semiconductor layer 114, an ohmic contact layer 115, a plurality of source lines 120, a plurality of source electrodes 122 and a plurality of drain electrodes 124. The semiconductor layer 114 is on the gate insulating layer 113 above each of the gate electrodes 112. The ohmic contact layer 115 is on the semiconductor layer 114. The source lines 120 extend in a second direction that is substantially perpendicular to the first direction. The unit pixel regions are defined by adjacent gate and source lines 110 and 120. The source electrodes 122 are electrically connected to the source lines 120. Each of the drain electrodes 124 is spaced apart from each of the source electrodes 122. Each of the gate electrodes 112, the semiconductor layer 114, the ohmic contact layer 115, each of the source electrodes 122 and each of the drain electrodes 124 form a thin film transistor (TFT).

Each of the gate and source lines 110 and 120 may have a mono-layered structure or a multi-layered structure. When each of the gate and source lines 110 and 120 has the mono-layered structure, each of the gate and source lines 110 and 120 includes aluminum, aluminum-alloy, etc. When each of the gate and source lines 110 and 120 has a double-layered structure, each of the gate and source lines 110 and 120 includes a lower layer and an upper layer. Examples of a material (metal or metal alloy) for the lower layer of each of the gate and source lines 110 and 120 include chromium, molybdenum, molybdenum alloy, etc. Examples of a material (metal or metal alloy) for the upper layer of each of the gate and source lines 110 and 120 include aluminum, aluminum alloy, etc.

The array substrate 100 may further include a passivation layer 130 and an organic insulating layer 132 on the passivation layer 130. The drain electrode 126 is partially exposed through a contact hole CNT of the passivation layer 130 and the organic insulating layer 132. The passivation layer 130 and the organic insulating layer 132 cover the semiconductor layer 114 and the ohmic contact layer 115 between the source and drain electrodes 122 and 124 to protect the semiconductor layer 114 and the ohmic contact layer 115. A pixel electrode member 140 is electrically insulated from the TFT by the passivation layer 130 and the organic insulating layer 132. The passivation layer 130 and the organic insulating layer 132 control a thickness of the liquid crystal layer 200. In some embodiments, the passivation layer 130 may be omitted.

The array substrate 100 may further include the pixel electrode member 140 that is electrically connected to the drain electrode 124 of the TFT through the contact hole CNT. The pixel electrode member 140 has a plurality of patterned openings that are arranged in various directions. The pixel electrode member 140 partially overlaps the lower storage pattern 111 to define a capacitance of a storage capacitor Cst.

In particular, the pixel electrode member 140 includes a first connecting electrode 141, a first sub electrode 142, a second connecting electrode 143, a second sub electrode 144, a third connecting electrode 145 and a third sub electrode 146. The first connecting electrode 141 is electrically connected to the drain electrode 124 of the TFT. The first sub electrode 142 is electrically connected to the first connecting electrode 141, and has a quadrangular shape with rounded corners. The second connecting electrode 143 is electrically connected to the first sub electrode 142, and has a smaller width than the first sub electrode 142. The second sub electrode 144 is electrically connected to the second connecting electrode 143, and has a quadrangular shape with rounded corners. The third connecting electrode 145 is electrically connected to the second sub electrode 144, and has a smaller width than the second sub electrode 144. The third sub electrode 146 is electrically connected to the third connecting electrode 145, and has a quadrangular shape with rounded corners.

Each of the first, second and third sub electrodes 142, 144 and 146 has a plurality of linearly patterned openings 142a, 144a and 146a that are arranged in a radial direction with respect to a center of each of the first, second and third sub electrodes 142, 144 and 146. In the LCD device in FIG. 1, each of the first, second and third sub electrodes 142, 144 and 146 has sixteen linearly patterned openings.

The color filter substrate 300 includes a first transparent substrate 305, a color filter layer 310 on the first transparent substrate 305 and a common electrode member 320 on the color filter layer 310. The color filter substrate 300 is combined with the array substrate 100 so that the liquid crystal layer 200 is interposed between the color filter substrate 300 and the array substrate 100. In the LCD device in FIGS. 1 and 2, the liquid crystal layer 200 is in a vertical alignment (VA) mode.

Generally, a rubbing process is used with an alignment layer to align the liquid crystal molecules in the desired orientation. However, the sixteen domains that are formed on each of the first, second and third sub electrodes 142, 144 and 146 make the rubbing process and the alignment layer unnecessary.

According to the LCD device in FIGS. 1 and 2, the array substrate includes the pixel electrode member having the three sub electrodes, and each of the sub electrodes includes the patterned openings arranged in the radial direction. The common electrode member may not have any patterned opening. Therefore, the liquid crystal layer 200 on the pixel electrode member has multiple domains in the unit pixel region.

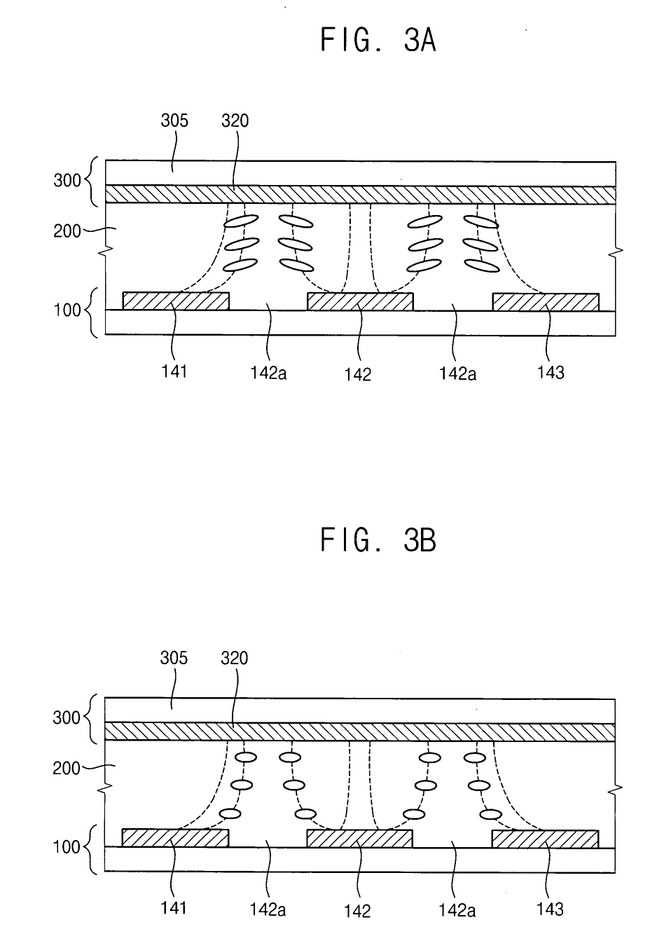

FIGS. 3A and 3B are cross-sectional views showing an operation of an LCD panel of the LCD device shown in FIG. 1. In particular, FIGS. 3A and 3B illustrate an arrangement of the liquid crystal layer 200 in the unit pixel region. The multi-domain is defined by openings 142a between the first connecting electrode 141, the first sub electrode 142 and the second connecting electrode 143.

When a voltage is not applied to the pixel electrode member 140, liquid crystals of the liquid crystal layer 200 are vertically aligned. When the voltage is applied to the pixel electrode member 140, the arrangement of the liquid crystals of the liquid crystal layer 200 changes. In an initial stage of the voltage application, the liquid crystals are inclined with respect to an electric field formed by the pixel electrode member 140. The electric field may be a disclination.

After the initial stage of the voltage application, the liquid crystals are tilted so that the liquid crystals are concentrated near the central portion of each of the first, second and third sub electrodes to display an image.

That is, the patterned openings 142a are formed only on the array substrate 100 to form multiple domains. The LCD device of FIGS. 1 to 3B has a greater light transmittance than a conventional LCD device operating in the VA mode. In addition, the storage capacitor may be formed in a peripheral region of the unit pixel region.

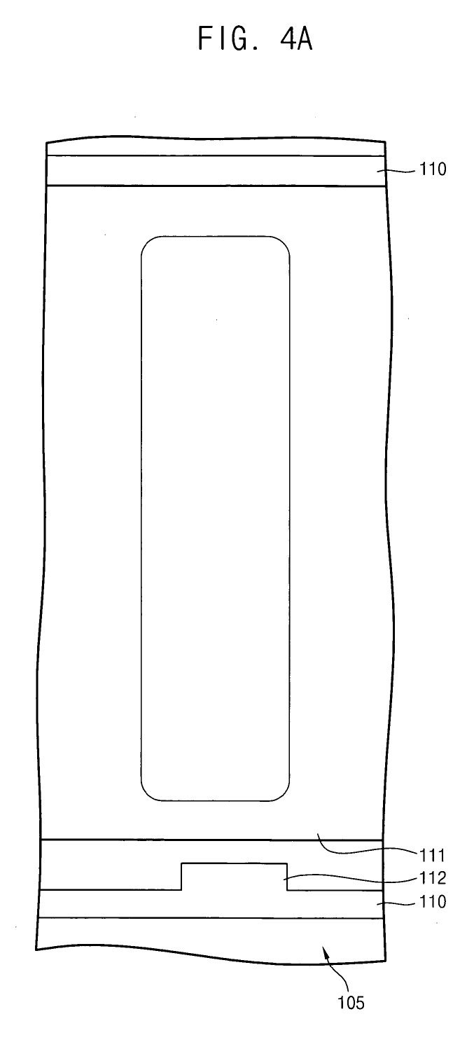

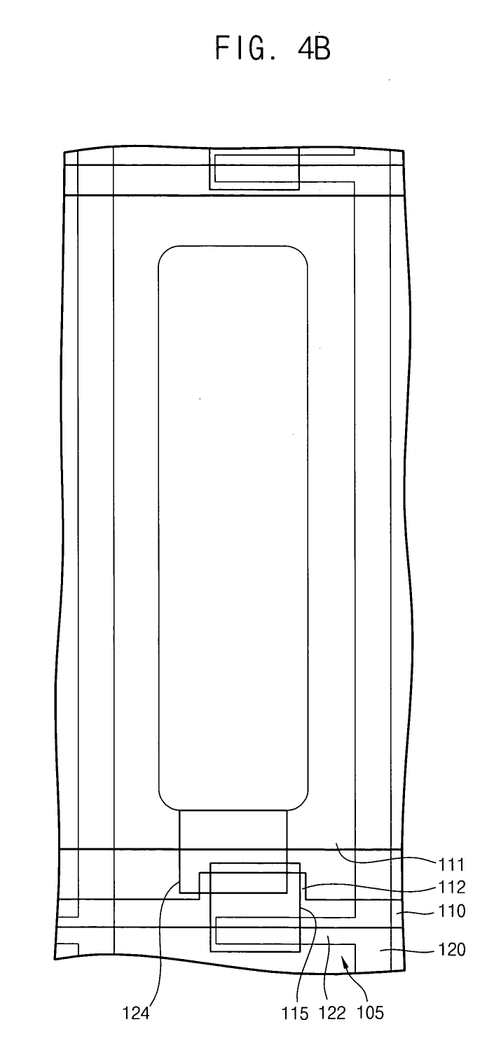

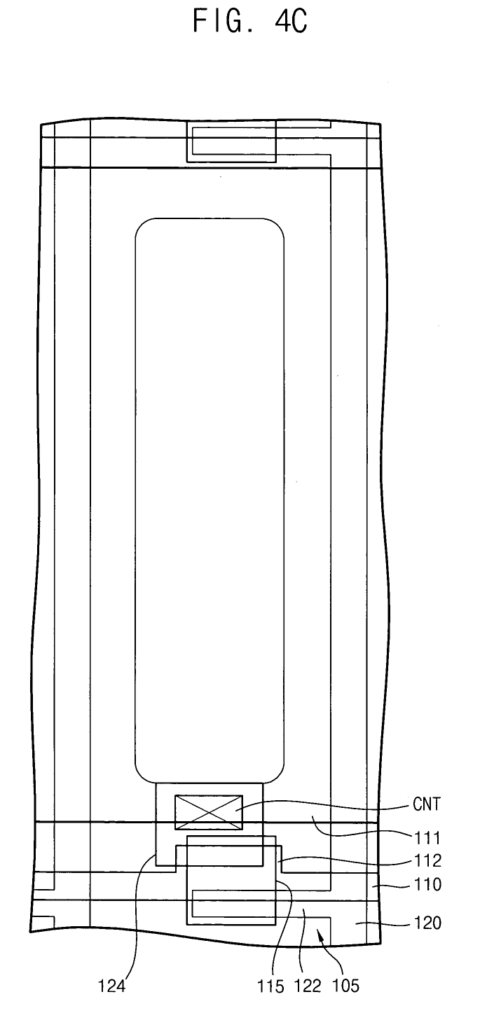

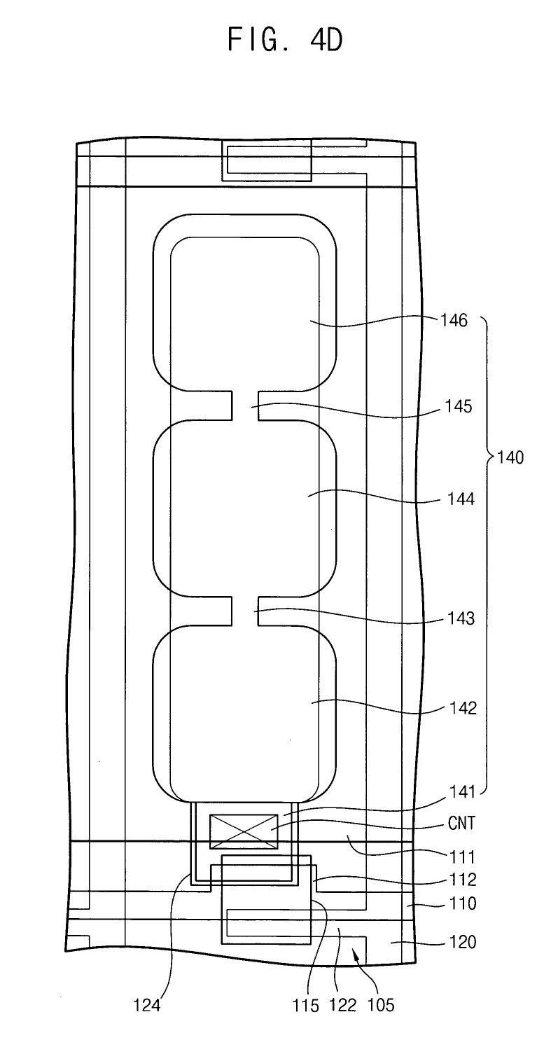

FIGS. 4A to 4D are plan views showing a method of manufacturing an array substrate of the LCD device shown in FIG. 1.

Referring to FIG. 4A, a metal or a metal alloy is deposited on the second transparent substrate 105. Examples of a material (metal or metal alloy) for the gate lines 110, the lower storage pattern 111 and the gate electrodes 112 may include aluminum, aluminum alloy, silver, silver alloy, copper, copper alloy, molybdenum, molybdenum alloy, chromium, tantalum, titanium, etc.

The deposited metal or metal alloy layer is patterned to form the gate lines 110, the lower storage pattern 111 and the gate electrodes 112. The gate lines 110 extend in the first direction and are arranged in the second direction. The lower storage pattern 111 is substantially in parallel with the gate lines 110, and has a quadrangular opening. The gate electrodes 112 are electrically connected to the gate lines 110.

Silicon nitride is deposited on the second transparent substrate 105 having the gate electrodes 112 to form the gate insulating layer 113. The silicon nitride may be deposited through a plasma enhanced chemical vapor deposition method. The gate insulating layer 113 may be formed on an entire surface of the second transparent substrate 105. Alternatively, the gate insulating layer 113 may partially cover the gate lines 110 and the gate electrodes 112.

Referring to FIG. 4B, an amorphous silicon is deposited on the gate insulating layer 113. N+ impurities are implanted on the deposited amorphous silicon layer to form an amorphous silicon layer and an N+ amorphous silicon layer. The amorphous silicon layer and the N+ amorphous silicon layer are patterned to form the active layer 115 on the gate insulating layer 113 corresponding to the gate electrode 112.

A metal or a metal alloy is deposited on the gate insulating layer 113 having the active layer 115. Examples of a material (metal or metal alloy) for the source lines 120, the source electrodes 122 and the drain electrodes 124 include aluminum, aluminum alloy, silver, silver alloy, copper, copper alloy, molybdenum, molybdenum alloy, chromium, tantalum, titanium, etc. The deposited metal or metal alloy layer is patterned to form the source lines 120, the source electrodes 122 and the drain electrodes 124. The source electrodes 122 are electrically connected to the source lines 120. Each of the drain electrodes 124 are spaced apart from each of the source electrodes 122.

Referring to FIG. 4C, an inorganic insulating material is deposited on the gate insulating layer 113 having the source electrodes 122 to form the passivation layer 130. An organic insulating material having a photoresist is coated on the passivation layer 130 to form the organic insulating layer 132. The passivation layer 130 and the organic insulating layer 132 are partially removed to form the contact hole CNT in the unit pixel region. Each of the drain electrodes 124 is partially exposed through the contact hole CNT. The unit pixel region is defined by the adjacent gate and data lines 110 and 120.

Referring to FIG. 4D, a transparent conductive material is deposited on the organic insulating layer 132. The deposited transparent conductive material layer is patterned to form the pixel electrode member 140 that is electrically connected to the drain electrode 124 through the contact hole CNT.

In particular, the pixel electrode member 140 includes the first connecting electrode 141, the first sub electrode 142, the second connecting electrode 143, the second sub electrode 144, the third connecting electrode 145 and the third sub electrode 146. The first connecting electrode 141 is electrically connected to the drain electrode 124 of the TFT. The first sub electrode 142 is electrically connected to the first connecting electrode 141, and has a quadrangular shape with rounded corners. The second connecting electrode 143 is electrically connected to the first sub electrode 142, and has a smaller width than the first sub electrode 142. The second sub electrode 144 is electrically connected to the second connecting electrode 143, and has a quadrangular shape with rounded corners. The third connecting electrode 145 is electrically connected to the second sub electrode 144, and has a smaller width than the second sub electrode 144. The third sub electrode 146 is electrically connected to the third connecting electrode 145, and has a quadrangular shape with rounded corners.

Examples of the transparent conductive material that can be used for the pixel electrode member 140 include indium tin oxide (ITO), indium zinc oxide (IZO), tin oxide (TO), zinc oxide (ZO), indium tin zinc oxide (ITZO), etc. In FIG. 4D, the transparent conductive material is deposited on the entire surface of the organic insulating layer 132, and the deposited transparent conductive material layer is partially etched to form the pixel electrode member 140. Alternatively, the transparent conductive material may be partially deposited on the organic insulating layer 132 to directly form the pixel electrode member 140. In FIG. 4D, the pixel electrode member 140 is spaced apart from the gate and source lines 110 and 120. In other embodiments, the pixel electrode member 140 may partially overlap the gate and/or source lines 110 and 120 by a predetermined distance.

The linearly patterned openings 142a, 144a and 146a that are arranged in the radial direction are then formed on the first, second and third sub electrodes 142, 144 and 146 of the pixel electrode member 140. The number of the linearly patterned openings 142a, 144a and 146a on each of the first, second and third sub electrodes 142, 144 and 146 is sixteen. The linearly patterned openings 142a, 144a and 146a form a distorted electric field to form the multi-domain having the domains. The linearly patterned openings 142a, 144a and 146a are formed through the patterning process for forming the pixel electrode member 140. Alternatively, the linearly patterned openings 142a, 144a and 146a may be formed through different patterning process from the forming of the pixel electrode member 140.

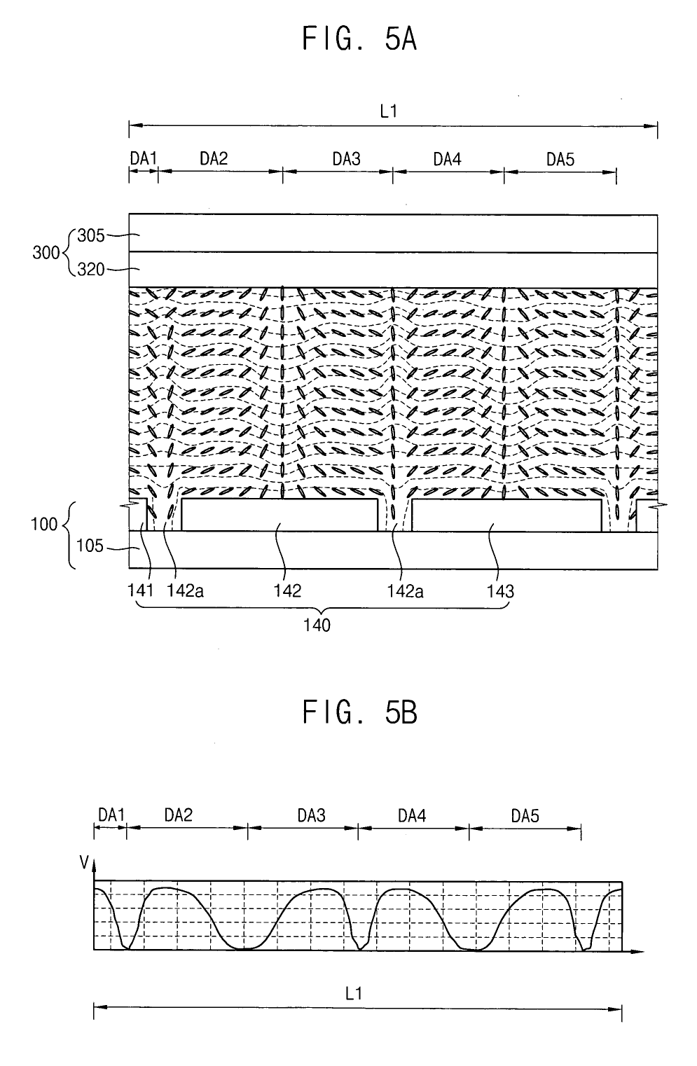

FIG. 5A is a cross-sectional view showing an operation of the LCD device shown in FIG. 1. FIG. 5B is a graph showing a voltage applied to a liquid crystal layer of the LCD device shown in FIG. 1.

Referring to FIG. 5A, the color filter substrate 300 includes the first transparent substrate 305 and the common electrode member 320 on the first transparent substrate 305. The array substrate 100 includes the second transparent substrate 105 and the pixel electrode member 140 having the linearly patterned openings 142a.

In operation, a first domain region DA1 is defined by the linearly patterned opening 142a adjacent to the first connecting electrode 141. A second domain region DA2 is defined by the linearly patterned opening 142a adjacent to a left side of the first sub electrode 142. A third domain region DA3 is defined by the linearly patterned opening 142a adjacent to a right side of the first sub electrode 142. A fourth domain region DA4 is defined by the linearly patterned opening 142a adjacent to a left side of the second connecting electrode 143. A fifth domain region DA5 is defined by the linearly patterned opening 142a adjacent to a right side of the second connecting electrode 143. Levels of the voltage applied to the liquid crystal layer corresponding to the first, second, third, fourth and fifth domain regions DA1, DA2, DA3, DA4 and DA5 vary so that the arrangements of the liquid crystals in the first, second, third, fourth and fifth domain regions DA1, DA2, DA3, DA4 and DA5 are not necessarily the same.

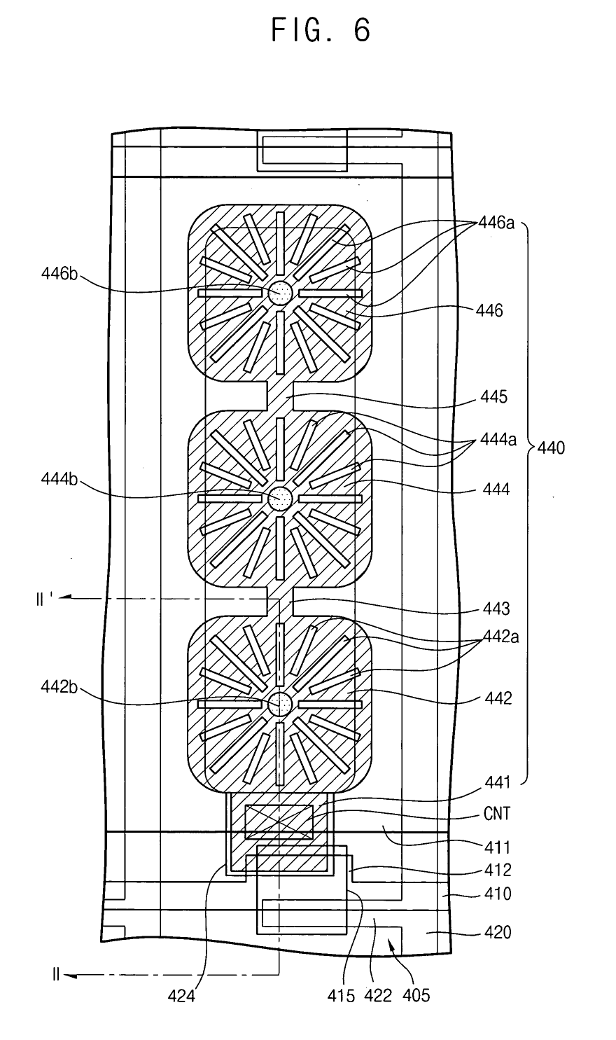

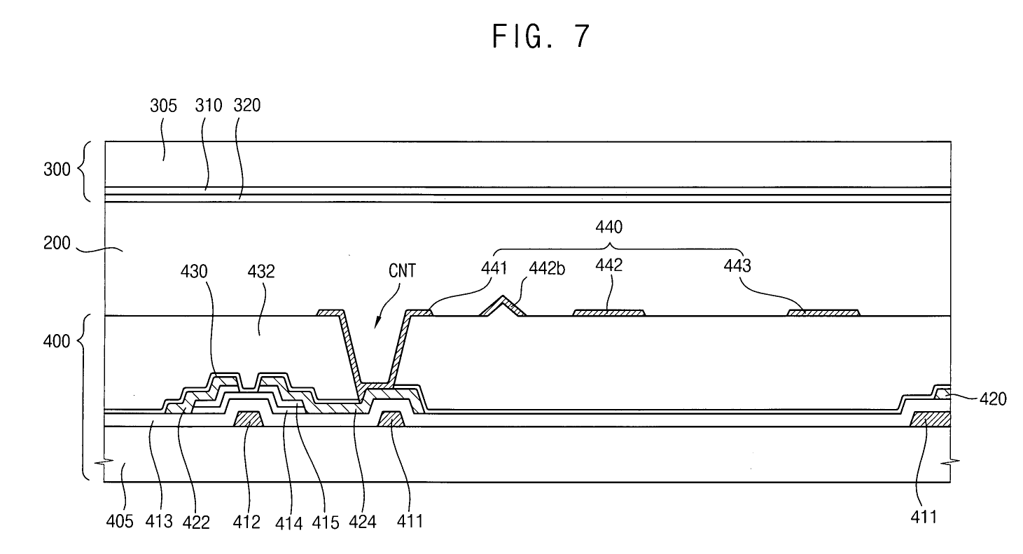

FIG. 6 is a plan view showing an array substrate in accordance with another embodiment of the present invention. FIG. 7 is a cross-sectional view taken along a line II-II′ shown in FIG. 6. The array substrate of FIGS. 6 and 7 is substantially similar to the array substrate in FIGS. 1 to 2 except for the presence of a protrusion electrode.

Referring to FIGS. 6 and 7, the LCD device includes an array substrate 400, a liquid crystal layer 200 and a color filter substrate 300. The color filter substrate 300 is combined with the array substrate 400 so that the liquid crystal layer 200 is interposed between the color filter substrate 300 and the array substrate 400.

The array substrate 400 includes a second transparent substrate 405, a plurality of gate lines 410, a plurality of gate electrodes 412, a lower storage pattern 411 and a gate insulating layer 413. The gate lines 410 are on the second transparent substrate 405 and extend in a first direction as shown in FIG. 6. The gate electrodes 412 are electrically connected to the gate lines 410. Each of the lower storage patterns 411 is spaced apart from each of the gate lines 410 in each of the unit pixel regions. The gate insulating layer 413 includes an insulating material to cover the gate lines 410 and the gate electrodes 412. Examples of the insulating material that can be used for the gate insulating layer 413 include silicon nitride, silicon oxide, etc.

The array substrate 400 may further include a semiconductor layer 414, an ohmic contact layer 415, a plurality of source lines 420, a plurality of source electrodes 422 and a plurality of drain electrodes 424. The semiconductor layer 414 is on the gate insulating layer 413 above each of the gate electrodes 412. The ohmic contact layer 415 is on the semiconductor layer 414. The source lines 420 extend in a second direction that is substantially perpendicular to the first direction. The unit pixel regions are defined by adjacent gate and source lines 410 and 420. The source electrodes 422 are electrically connected to the source lines 420. Each of the drain electrodes 424 is spaced apart from each of the source electrodes 422. Each of the gate electrodes 412, the semiconductor layer 414, the ohmic contact layer 415, each of the source electrodes 422 and each of the drain electrodes 424 form a thin film transistor (TFT).

Each of the gate and source lines 410 and 420 may have a mono-layered structure or a multi-layered structure. When each of the gate and source lines 410 and 420 has the mono-layered structure, each of the gate and source lines 410 and 420 includes aluminum, aluminum-alloy, etc. When each of the gate and source lines 410 and 420 has a double-layered structure, each of the gate and source lines 410 and 420 includes a lower layer and an upper layer. Examples of a material (metal or metal alloy) for the lower layer of each of the gate and source lines 410 and 420 include chromium, molybdenum, molybdenum alloy, etc. Examples of a material (metal or metal alloy) for the upper layer of each of the gate and source lines 410 and 420 include aluminum, aluminum alloy, etc.

The array substrate 400 may further include a passivation layer 430 and an organic insulating layer 432 on the passivation layer 430. The drain electrode 426 is partially exposed through a contact hole CNT of the passivation layer 430 and the organic insulating layer 432. The passivation layer 430 and the organic insulating layer 432 cover the semiconductor layer 414 and the ohmic contact layer 415 between the source and drain electrodes 422 and 424 to protect the semiconductor layer 414 and the ohmic contact layer 415. A pixel electrode member 440 is electrically insulated from the TFT by the passivation layer 430 and the organic insulating layer 432. The passivation layer 430 and the organic insulating layer 432 control a thickness of the liquid crystal layer 200. In some embodiments, the passivation layer 430 may be omitted.

The array substrate 400 may further include the pixel electrode member 440 that is electrically connected to the drain electrode 424 of the TFT through the contact hole CNT. The pixel electrode member 440 has a plurality of patterned openings that are arranged in various directions. The pixel electrode member 440 is partially overlapped with the lower storage pattern 411 to define a capacitance of a storage capacitor Cst.

In particular, the pixel electrode member 440 includes a first connecting electrode 441, a first sub electrode 442, a second connecting electrode 443, a second sub electrode 444, a third connecting electrode 445 and a third sub electrode 446. The first connecting electrode 441 is electrically connected to the drain electrode 424 of the TFT. The first sub electrode 442 is electrically connected to the first connecting electrode 441, and has a quadrangular shape with rounded corners. The second connecting electrode 443 is electrically connected to the first sub electrode 442, and has a smaller width than the first sub electrode 442. The second sub electrode 444 is electrically connected to the second connecting electrode 443, and has a quadrangular shape with rounded corners. The third connecting electrode 445 is electrically connected to the second sub electrode 444, and has a smaller width than the second sub electrode 444. The third sub electrode 446 is electrically connected to the third connecting electrode 445, and has a quadrangular shape with rounded corners.

Each of the first, second and third sub electrodes 442, 444 and 446 has a plurality of linearly patterned openings 442a, 444a and 446a that are arranged in a radial direction with respect to a center of each of the first, second and third sub electrodes 442, 444 and 446. In the LCD device in FIG. 6, each of the first, second and third sub electrodes 442, 444 and 446 has sixteen linearly patterned openings. The first, second and third sub electrodes 442, 444 and 446 include a first protruding electrode portion 442b, a second protruding electrode portion 444b and a third protruding electrode portion 446b. In the array substrate of FIG. 6, each of the first, second and third protruding electrode portions 442b, 444b and 446b has a circular shape. This is, however, not a limitation of the invention and each of the first, second and third protruding electrode portions 442b, 444b and 446b may have a quadrangular shape, an octagonal shape, etc. in other embodiments.

The color filter substrate 300 includes a first transparent substrate 305, a color filter layer 310 on the first transparent substrate 305 and a common electrode member 320 on the color filter layer 310. The color filter substrate 300 is combined with the array substrate 400 so that the liquid crystal layer 200 is interposed between the color filter substrate 300 and the array substrate 400. In the LCD device in FIGS. 6 and 7, the liquid crystal layer 200 operates in the vertical alignment (VA) mode.

Sixteen domains are formed on each of the first, second and third sub electrodes 442, 444 and 446. As explained above, the presence of multiple domains allows the rubbing process and the alignment layer to be omitted.

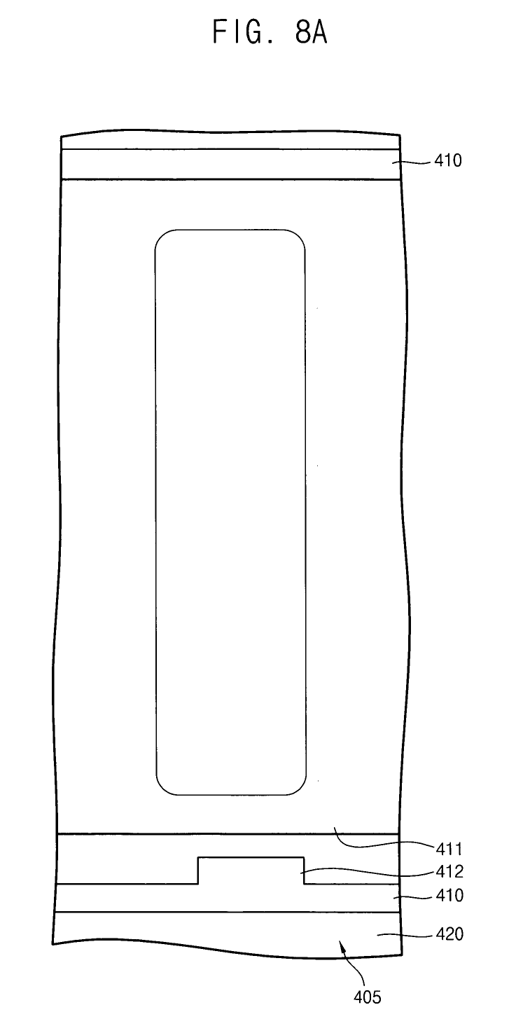

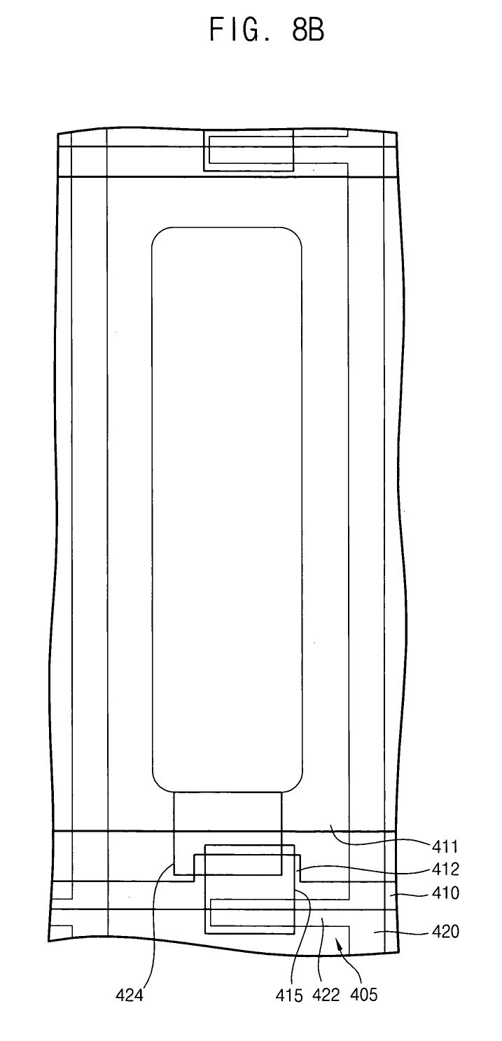

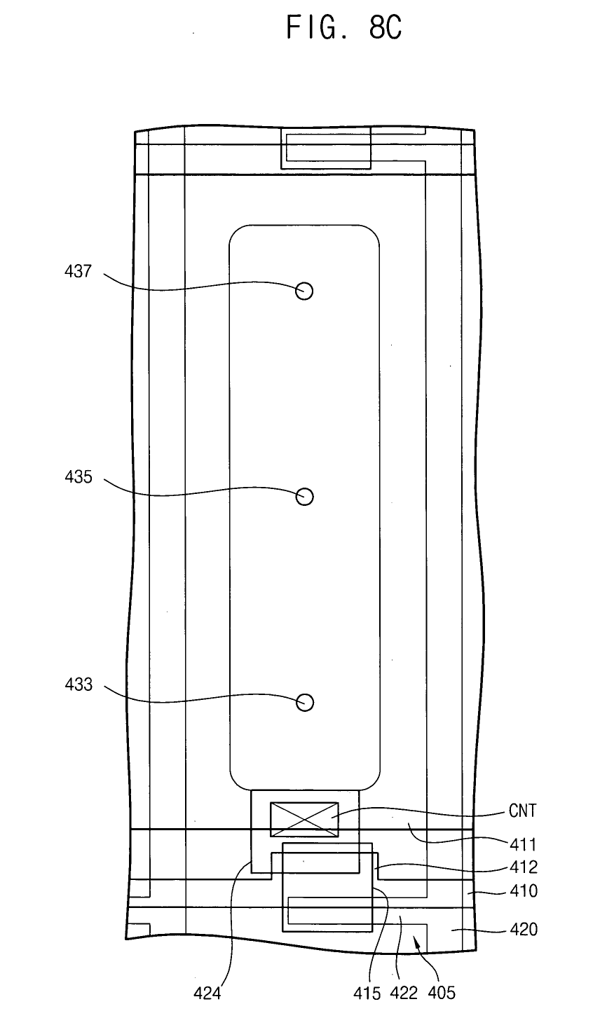

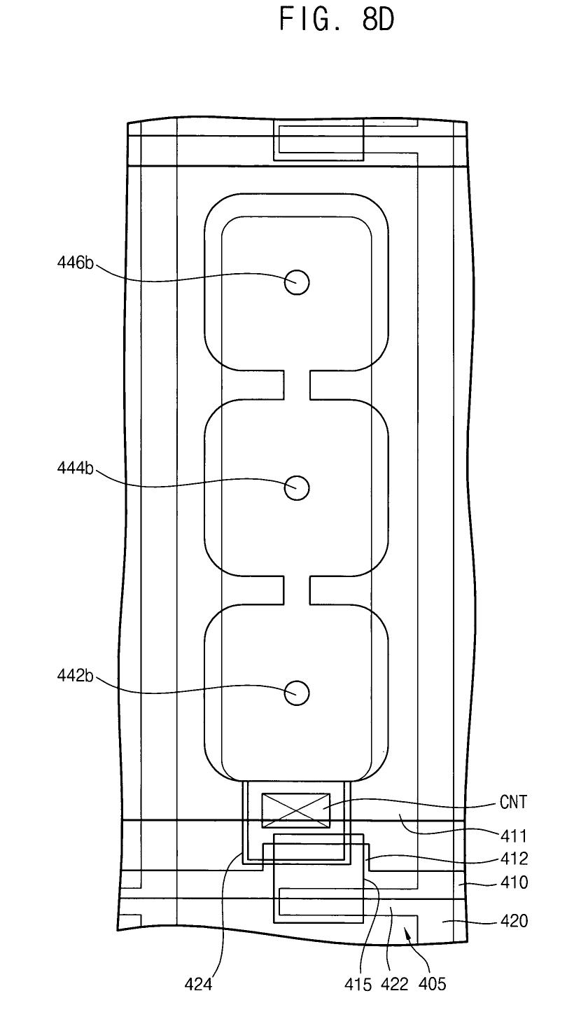

FIGS. 8A to 8D are cross-sectional views showing a method of manufacturing the array substrate shown in FIG. 6.

Referring to FIG. 8A, a metal or a metal alloy is deposited on the second transparent substrate 405. Examples of a material (metal or metal alloy) for the gate lines 410, the lower storage pattern 411 and the gate electrodes 412 include aluminum, aluminum alloy, silver, silver alloy, copper, copper alloy, molybdenum, molybdenum alloy, chromium, tantalum, titanium, etc. The deposited metal or metal alloy layer is patterned to form the gate lines 410, the lower storage pattern 411 and the gate electrodes 412. The gate lines 410 extend in the first direction, and are arranged in the second direction. The lower storage pattern 411 is substantially in parallel with the gate lines 410, and has a quadrangular opening. The gate electrodes 412 are electrically connected to the gate lines 410.

Silicon nitride is deposited on the second transparent substrate 405 having the gate electrodes 412 to form the gate insulating layer 413. The silicon nitride may be deposited through a plasma enhanced chemical vapor deposition method. The gate insulating layer 413 may be formed on the entire surface of the second transparent substrate 405. Alternatively, the gate insulating layer 413 may partially cover the gate lines 410 and the gate electrodes 412.

Referring to FIG. 8B, an amorphous silicon is deposited on the gate insulating layer 413. N+ impurities are implanted on the deposited amorphous silicon layer to form an amorphous silicon layer and an N+ amorphous silicon layer. The amorphous silicon layer and the N+ amorphous silicon layer are patterned to form the active layer 415 on the gate insulating layer 413 corresponding to the gate electrode 412.

A metal or a metal alloy is deposited on the gate insulating layer 413 having the active layer 415. Examples of a material (metal or metal alloy) for the source lines 420, the source electrodes 422 and the drain electrodes 424 include aluminum, aluminum alloy, silver, silver alloy, copper, copper alloy, molybdenum, molybdenum alloy, chromium, tantalum, titanium, etc. The deposited metal or metal alloy layer is patterned to form the source lines 420, the source electrodes 422 and the drain electrodes 424. The source electrodes 422 are electrically connected to the source lines 420. Each of the drain electrodes 424 is spaced apart from each of the source electrodes 422.

Referring to FIG. 8C, an inorganic insulating material is deposited on the gate insulating layer 413 having the source electrodes 422 to form the passivation layer 430. An organic insulating material having a photoresist is coated on the passivation layer 430 to form the organic insulating layer 432. The passivation layer 430 and the organic insulating layer 432 are partially removed to form the contact hole CNT and a first protrusion 433, a second protrusion 435 and a third protrusion 437 in the unit pixel region. Each of the drain electrodes 424 is partially exposed through the contact hole CNT. The unit pixel region is defined by the adjacent gate and data lines 410 and 420.

Referring to FIG. 8D, a transparent conductive material is deposited on the organic insulating layer 432 having the first, second and third protrusions 433, 435 and 437. The deposited transparent conductive material layer is patterned to form the pixel electrode member 440 that is electrically connected to the drain electrode 424 through the contact hole. In particular, the pixel electrode member 440 includes the a first connecting electrode 441, the first sub electrode 442, the second connecting electrode 443, the second sub electrode 444, the third connecting electrode 445 and the third sub electrode 446. The first connecting electrode 441 is electrically connected to the drain electrode 424 of the TFT. The first sub electrode 442 is electrically connected to the first connecting electrode 441, and has a quadrangular shape with rounded corners. The second connecting electrode 443 is electrically connected to the first sub electrode 442, and has a smaller width than the first sub electrode 442. The second sub electrode 444 is electrically connected to the second connecting electrode 443, and has a quadrangular shape with rounded corners. The third connecting electrode 445 is electrically connected to the second sub electrode 444, and has a smaller width than the second sub electrode 444. The third sub electrode 446 is electrically connected to the third connecting electrode 445, and has a quadrangular shape with rounded corners.

Examples of the transparent conductive material that can be used for the pixel electrode member 440 include indium tin oxide (ITO), indium zinc oxide (IZO), tin oxide (TO), zinc oxide (ZO), indium tin zinc oxide (ITZO), etc. In FIG. 8D, the transparent conductive material is deposited on the entire surface of the organic insulating layer 432 having the first, second and third protrusions 433, 435 and 437, and the deposited transparent conductive material layer is partially etched to form the pixel electrode member 440. Alternatively, the transparent conductive material may be partially deposited on the organic insulating layer 432 to directly form the pixel electrode member 440. In FIG. 8D, the pixel electrode member 440 is spaced apart from the gate and source lines 410 and 420. In other embodiments, the pixel electrode member 440 may partially overlap the gate and/or source lines 410 and 420 by a predetermined distance.

The linearly patterned openings 442a, 444a and 446a that are arranged in the radial direction are then formed on the first, second and third sub electrodes 442, 444 and 446 of the pixel electrode member 440. The number of the linearly patterned openings 442a, 444a and 446a on each of the first, second and third sub electrodes 442, 444 and 446 is sixteen. The linearly patterned openings 442a, 444a and 446a form a distorted electric field to form the multi-domain. In addition, the first, second and third protruding electrode portions 442b, 444b and 446b also form a distorted electric field to form the multiple domains. The linearly patterned openings 442a, 444a and 446a are formed through the patterning process for forming the pixel electrode member 440. Alternatively, the linearly patterned openings 442a, 444a and 446a may be formed through different patterning process from the forming of the pixel electrode member 440.

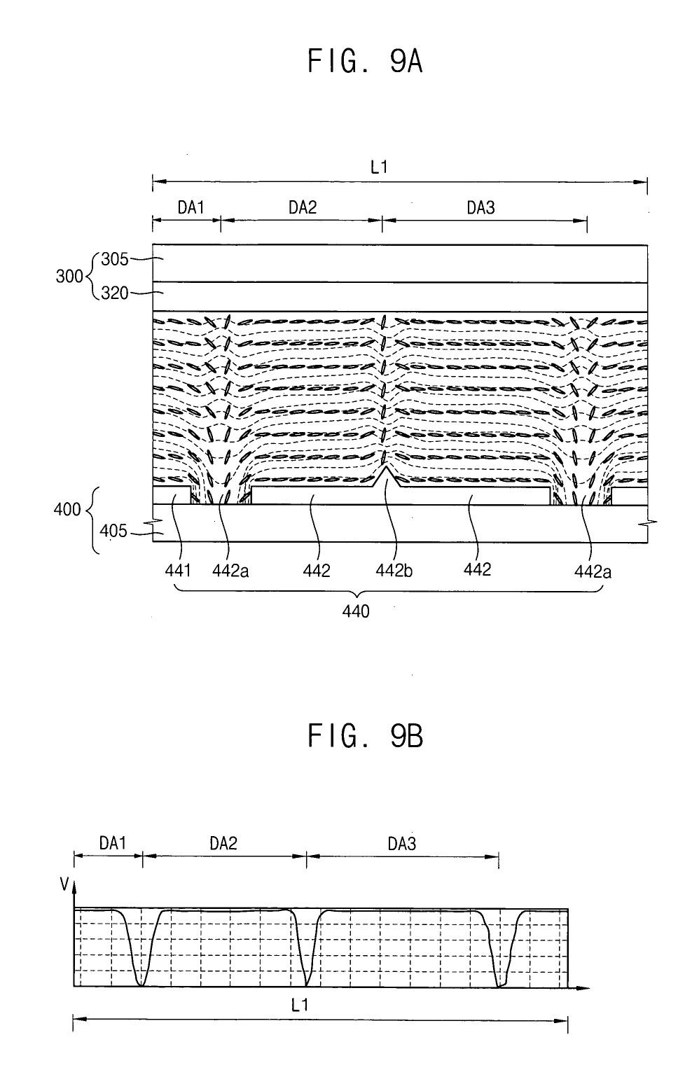

FIG. 9A is a cross-sectional view showing an operation of an LCD device having the array substrate shown in FIG. 6. FIG. 9B is a graph showing a voltage applied to a liquid crystal layer of the LCD device having the array substrate shown in FIG. 6. In particular, the color filter substrate 300 includes the common electrode member 320 having a flat shape. The array substrate 400 includes the pixel electrode member 440 having the linearly patterned openings 442a and the protruding electrode portion 442b.

Referring to FIG. 9A, the color filter substrate 300 includes the first transparent substrate 305 and the common electrode member 320 on the first transparent substrate 305. The array substrate 400 includes the second transparent substrate 405 and the pixel electrode member 440 having the linearly patterned openings 442a and the protruding electrode portion 442b.

In operation, a first domain region DA1 is defined by the linearly patterned opening 442a adjacent to the first connecting electrode 441. A second domain region DA2 is defined by the linearly patterned opening 442a adjacent to a left side of the first sub electrode 442. A third domain region DA3 is defined by the linearly patterned opening 442a adjacent to a right side of the first sub electrode 442. The protruding electrode portion 442b is between the second and third domain regions DA2 and DA3. Levels of the voltage applied to the liquid crystal layer corresponding to the first, second and third domain regions DA1, DA2 and DA3 vary so that the arrangements of the liquid crystals in the first, second and third domain regions DA1, DA2 and DA3 are not necessarily the same.

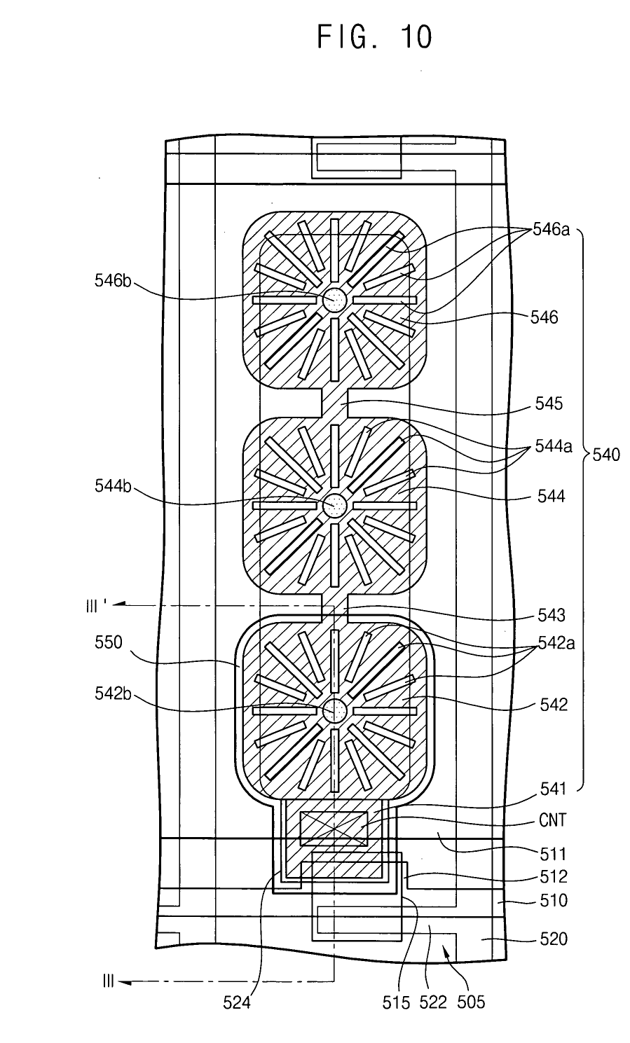

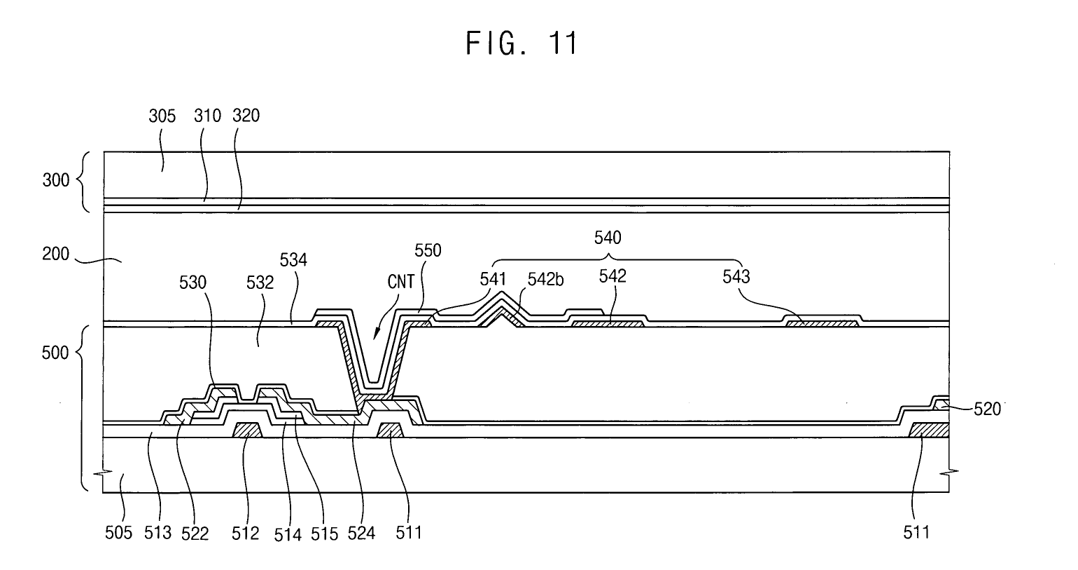

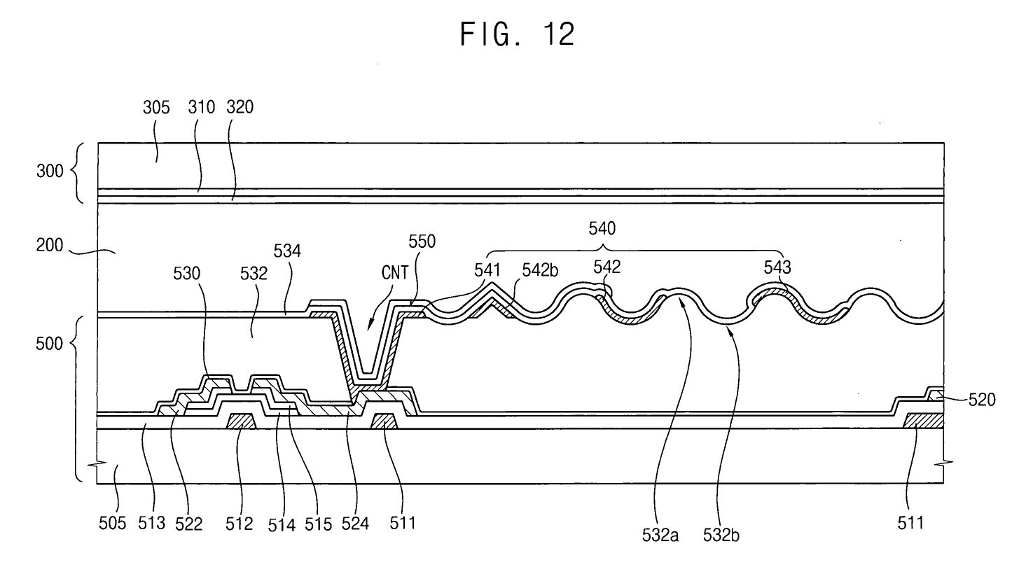

FIG. 10 is a plan view showing an array substrate in accordance with another embodiment of the present invention. FIG. 11 is a cross-sectional view taken along a line III-III′ shown in FIG. 10. The array substrate of FIGS. 10 and 11 is a transmissive-reflective typed array substrate.

Referring to FIGS. 10 and 11, the LCD device includes an arrays substrate 500, a liquid crystal layer 200 and a color filter substrate 300. The color filter substrate 300 is combined with the array substrate 500 so that the liquid crystal layer 200 is interposed between the color filter substrate 300 and the array substrate 500.

The array substrate 500 includes a second transparent substrate 505, a plurality of gate lines 510, a plurality of gate electrodes 512, a lower storage pattern 511 and a gate insulating layer 513. The gate lines 510 are on the second transparent substrate 505 extending in a first direction. The gate electrodes 512 are electrically connected to the gate lines 510. Each of the lower storage patterns 511 is spaced apart from each of the gate lines 510 in each of unit pixel regions. The gate insulating layer 513 includes an insulating material to cover the gate lines 510 and the gate electrodes 512. Examples of the insulating material that can be used for the gate insulating layer 513 include silicon nitride, silicon oxide, etc.

The array substrate 500 may further include a semiconductor layer 514, an ohmic contact layer 515, a plurality of source lines 520, a plurality of source electrodes 522 and a plurality of drain electrodes 524. The semiconductor layer 514 is on the gate insulating layer 513 above each of the gate electrodes 512. The ohmic contact layer 515 is on the semiconductor layer 514. The source lines 520 extend in a second direction that is substantially perpendicular to the first direction. The unit pixel regions are defined by adjacent gate and source lines 510 and 520. The source electrodes 522 are electrically connected to the source lines 520. Each of the drain electrodes 524 is spaced apart from each of the source electrodes 522. Each of the gate electrodes 512, the semiconductor layer 514, the ohmic contact layer 515, each of the source electrode 522 and each of the drain electrodes 524 form a thin film transistor (TFT).

Each of the gate and source lines 510 and 520 may have a mono-layered structure or a multi-layered structure. When each of the gate and source lines 510 and 520 has the mono-layered structure, each of the gate and source lines 510 and 520 includes aluminum, aluminum-alloy, etc. When each of the gate and source lines 510 and 520 has a double-layered structure, each of the gate and source lines 510 and 520 includes a lower layer and an upper layer. Examples of a material (metal or metal alloy) for the lower layer of each of the gate and source lines 510 and 520 include chromium, molybdenum, molybdenum alloy, etc. Examples of a material (metal or metal alloy) for the upper layer of each of the gate and source lines 510 and 520 include aluminum, aluminum alloy, etc.

The array substrate 500 may further include a passivation layer 530 and an organic insulating layer 532 on the passivation layer 530. The drain electrode 526 is partially exposed through a contact hole CNT of the passivation layer 530 and the organic insulating layer 532. The passivation layer 530 and the organic insulating layer 532 cover the semiconductor layer 514 and the ohmic contact layer 515 between the source and drain electrodes 522 and 524 to protect the semiconductor layer 514 and the ohmic contact layer 515. A pixel electrode member 540 is electrically insulated from the TFT by the passivation layer 530 and the organic insulating layer 532. The passivation layer 530 and the organic insulating layer 532 control a thickness of the liquid crystal layer 200. In some embodiments, the passivation layer 530 may be omitted.

The array substrate 500 may further include the pixel electrode member 540 that is electrically connected to the drain electrode 524 of the TFT through the contact hole CNT. The pixel electrode member 540 has a plurality of patterned openings that are arranged in various directions. The pixel electrode member 540 is partially overlapped with the lower storage pattern 511 to define a capacitance of a storage capacitor Cst.

In particular, the pixel electrode member 540 includes a first connecting electrode 541, a first sub electrode 542, a second connecting electrode 543, a second sub electrode 544, a third connecting electrode 545 and a third sub electrode 546. The first connecting electrode 541 is electrically connected to the drain electrode 524 of the TFT. The first sub electrode 542 is electrically connected to the first connecting electrode 541, and has a quadrangular shape with rounded corners. The second connecting electrode 543 is electrically connected to the first sub electrode 542, and has a smaller width than the first sub electrode 542. The second sub electrode 544 is electrically connected to the second connecting electrode 543, and has a quadrangular shape with rounded corners. The third connecting electrode 545 is electrically connected to the second sub electrode 544, and has a smaller width than the second sub electrode 544. The third sub electrode 546 is electrically connected to the third connecting electrode 545, and has a quadrangular shape with rounded corners.

Each of the first, second and third sub electrodes 542, 544 and 546 has a plurality of linearly patterned openings 542a, 544a and 546a that are arranged in a radial direction with respect to a center of each of the first, second and third sub electrodes 542, 544 and 546. In the LCD device in FIG. 10, each of the first, second and third sub electrodes 542, 544 and 546 has sixteen linearly patterned openings.

The array substrate 500 may further include an insulating interlayer 534 and a reflecting layer 550. The insulating interlayer 534 covers the organic insulating layer 532 and the pixel electrode member 540. The reflecting layer 550 is on the insulating interlayer 534 corresponding to a portion of the pixel electrode member 540 and the source lines 520.

In FIGS. 10 and 11, first, second and third protrusions 542b, 544b and 546b are on the organic insulating layer 532.

FIG. 12 is a cross-sectional view showing an LCD device in accordance with another embodiment of the present invention.

Referring to FIG. 12, a first portion 532a and a second portion 532b may be defined on each of the first, second and third sub electrodes 542, 544 and 546, and the protrusion may be formed on the first portion 532a or the second portion 532b.

Referring again to FIGS. 10 and 11, the color filter substrate 300 includes a first transparent substrate 305, a color filter layer 310 on the first transparent substrate 305 and a common electrode member 320 on the color filter layer 310. The color filter substrate 300 is combined with the array substrate 500 so that the liquid crystal layer 200 is interposed between the color filter substrate 300 and the array substrate 500. In the LCD device in FIGS. 10 and 11, the liquid crystal layer 200 has a vertical alignment (VA) mode.

Sixteen domains are formed on each of the first, second and third sub electrodes 542, 544 and 546. As explained above, the multiple domains allow the rubbing process and the alignment layer to be omitted.

In addition, the reflecting layer 550 is formed adjacent to an interface between the unit pixels so that the LCD device can operate in a reflective-transmissive mode. With the reflecting layer 550, the light that is irradiated into a region in which the liquid crystals are difficult to control is reflected, improving a n image display quality of the LCD device.

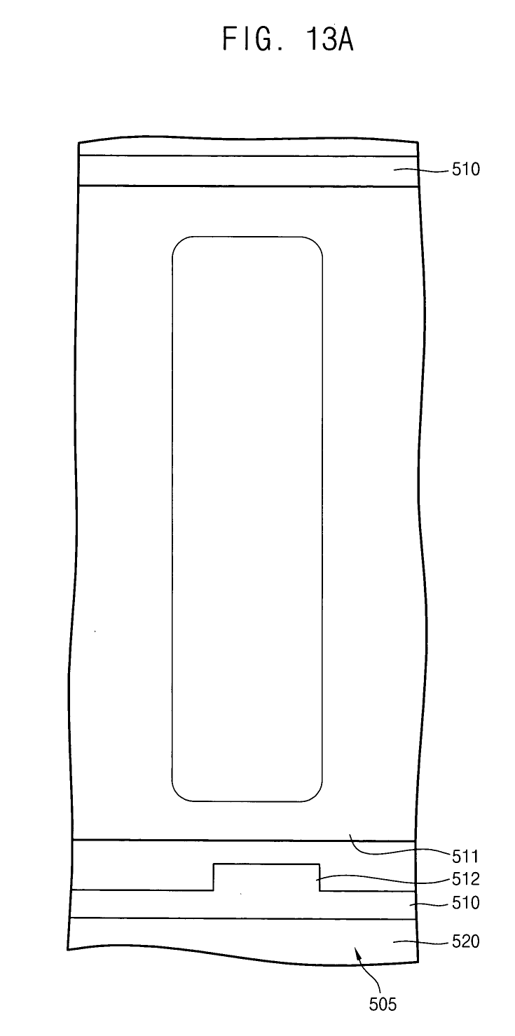

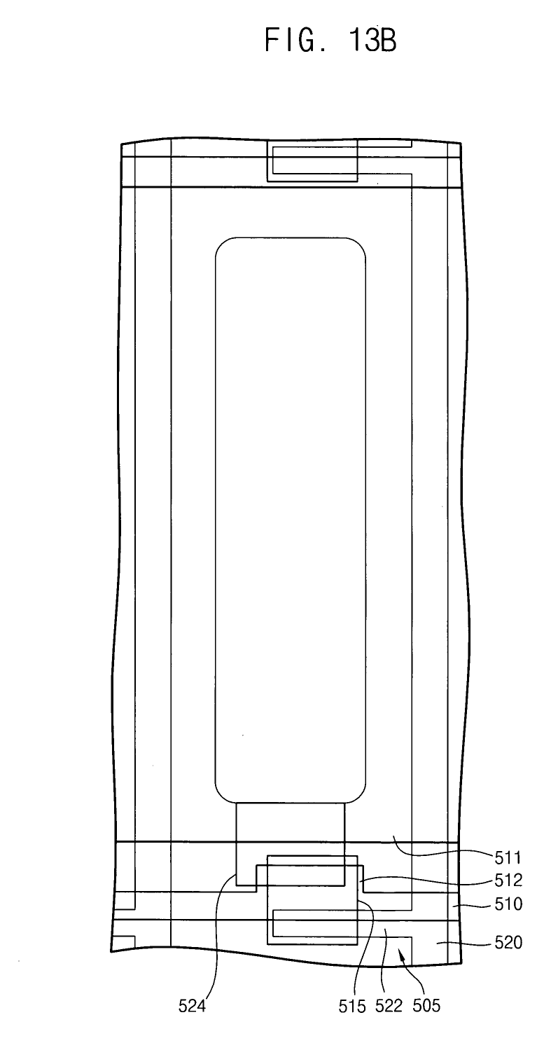

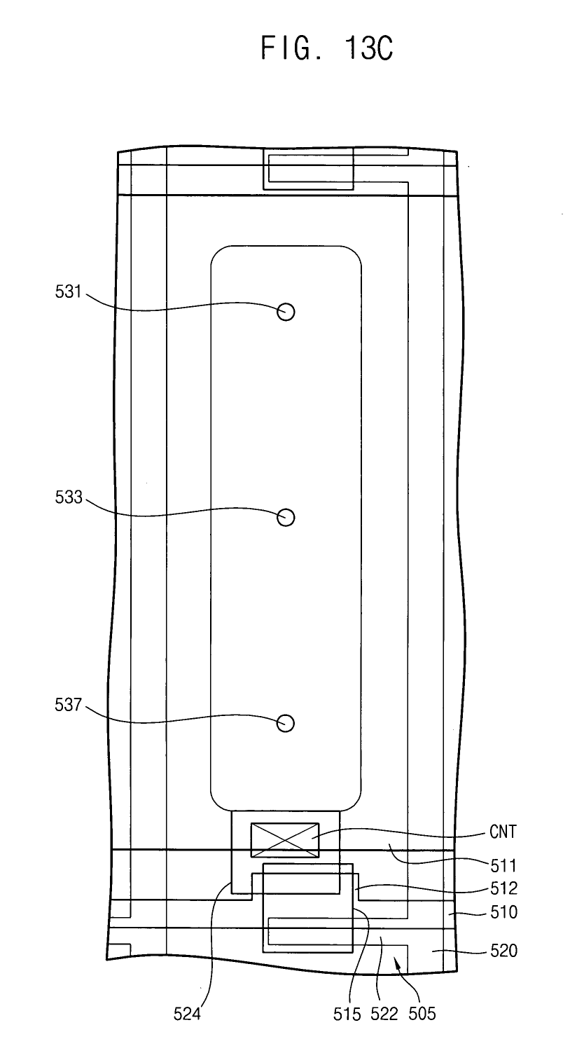

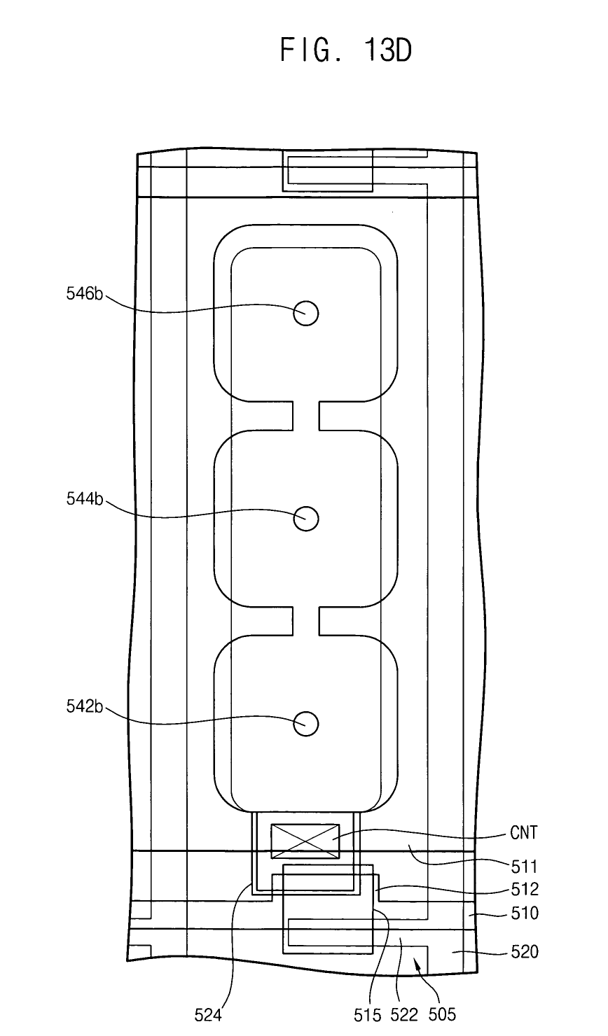

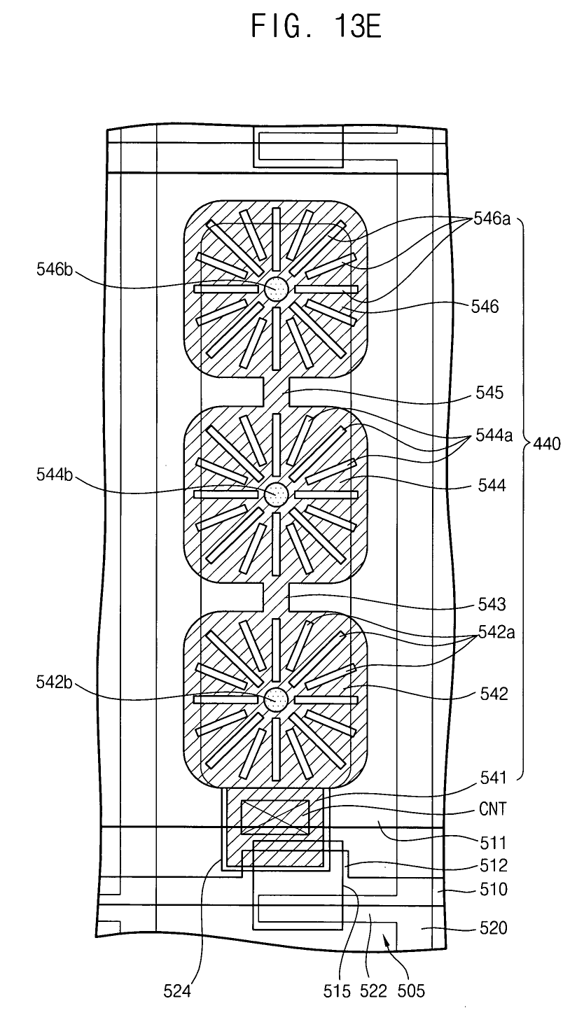

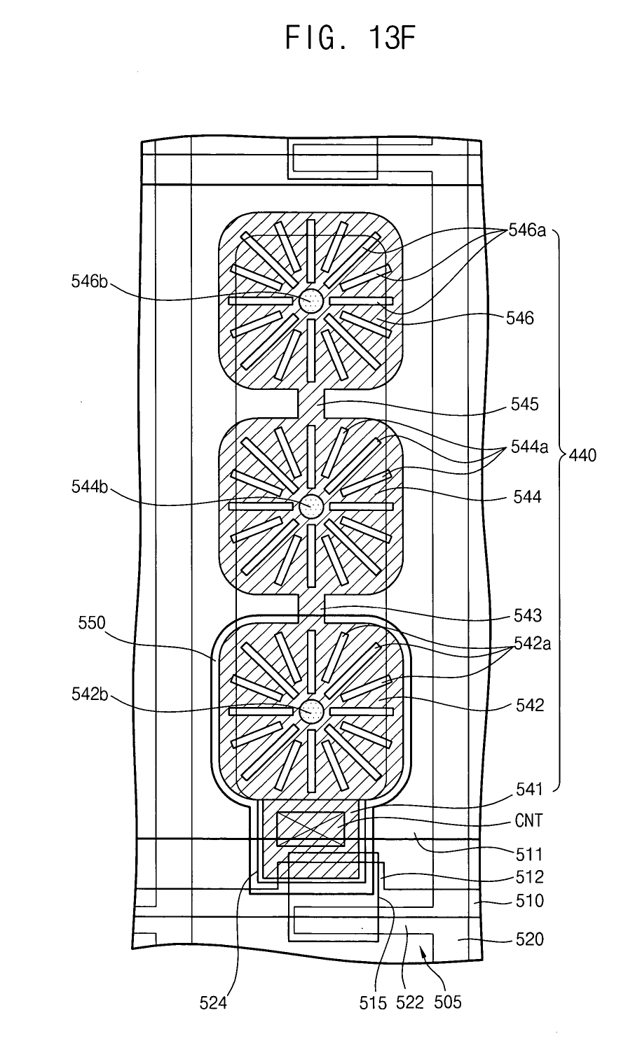

FIGS. 13A to 13F are plan views showing a method of manufacturing an array substrate shown in FIG. 10.

Referring to FIG. 13A, a metal or a metal alloy is deposited on the second transparent substrate 505. Examples of a material (metal or metal alloy) for the gate lines 510, the lower storage pattern 511 and the gate electrodes 512 include aluminum, aluminum alloy, silver, silver alloy, copper, copper alloy, molybdenum, molybdenum alloy, chromium, tantalum, titanium, etc. The deposited metal or metal alloy layer is patterned to form the gate lines 510, the lower storage pattern 511 and the gate electrodes 512. The gate lines 510 extend in the first direction and are arranged in the second direction. The lower storage pattern 511 is substantially in parallel with the gate lines 510, and has a quadrangular opening. The gate electrodes 512 are electrically connected to the gate lines 510.

Silicon nitride is deposited on the second transparent substrate 505 having the gate electrodes 512 to form the gate insulating layer 513. The silicon nitride may be deposited through a plasma enhanced chemical vapor deposition method. The gate insulating layer 513 may be formed on the entire surface of the second transparent substrate 505. Alternatively, the gate insulating layer 513 may partially cover the gate lines 510 and the gate electrodes 512.

Referring to FIG. 13B, an amorphous silicon is deposited on the gate insulating layer 513. N+ impurities are implanted on the deposited amorphous silicon layer to form an amorphous silicon layer and an N+ amorphous silicon layer. The amorphous silicon layer and the N+ amorphous silicon layer are patterned to form the active layer 515 on the gate insulating layer 513 corresponding to the gate electrode 512.

A metal or a metal alloy is deposited on the gate insulating layer 513 having the active layer 515. Examples of a material (metal or metal alloy) for the source lines 520, the source electrodes 522 and the drain electrodes 524 include aluminum, aluminum alloy, silver, silver alloy, copper, copper alloy, molybdenum, molybdenum alloy, chromium, tantalum, titanium, etc. The deposited metal or metal alloy layer is patterned to form the source lines 520, the source electrodes 522 and the drain electrodes 524. The source electrodes 522 are electrically connected to the source lines 520. Each of the drain electrodes 524 is spaced apart from each of the source electrodes 522.

Referring to FIG. 13C, an inorganic insulating material is deposited on the gate insulating layer 513 having the source electrodes 522 to form the passivation layer 530. An organic insulating material having a photoresist is coated on the passivation layer 530 to form the organic insulating layer 532. The passivation layer 530 and the organic insulating layer 532 are partially removed to form the contact hole CNT and a first protrusion 531, a second protrusion 533 and a third protrusion 537 in the unit pixel region. Each of the drain electrodes 524 is partially exposed through the contact hole CNT. The unit pixel region is defined by the adjacent gate and data lines 510 and 520.

Referring to FIG. 13D, a transparent conductive material is deposited on the organic insulating layer 532 having the first, second and third protrusions 531, 533 and 537 shown in FIG. 13C. The deposited transparent conductive material layer is patterned to form the pixel electrode member 540 that is electrically connected to the drain electrode 524 through the contact hole CNT. In particular, the pixel electrode member 540 includes the first connecting electrode 541, the first sub electrode 542, the second connecting electrode 543, the second sub electrode 544, the third connecting electrode 545 and the third sub electrode 546. The first connecting electrode 541 is electrically connected to the drain electrode 524 of the TFT. The first sub electrode 542 is electrically connected to the first connecting electrode 541, and has a quadrangular shape with rounded corners. The second connecting electrode 543 is electrically connected to the first sub electrode 542, and has a smaller width than the first sub electrode 542. The second sub electrode 544 is electrically connected to the second connecting electrode 543, and has a quadrangular shape with rounded corners. The third connecting electrode 545 is electrically connected to the second sub electrode 544, and has a smaller width than the second sub electrode 544. The third sub electrode 546 is electrically connected to the third connecting electrode 545, and has a quadrangular shape with rounded corners.

Examples of the transparent conductive material that can be used for the pixel electrode member 540 include indium tin oxide (ITO), indium zinc oxide (IZO), tin oxide (TO), zinc oxide (ZO), indium tin zinc oxide (ITZO), etc. In FIG. 13D, the transparent conductive material is deposited on the entire surface of the organic insulating layer 532 having the first, second and third protrusions 531, 533 and 537, and the deposited transparent conductive material layer is partially etched to form the pixel electrode member 540. Alternatively, the transparent conductive material may be partially deposited on the organic insulating layer 532 to directly form the pixel electrode member 540. In FIG. 13D, the pixel electrode member 540 is spaced apart from the gate and source lines 510 and 520. In other embodiments, the pixel electrode member 540 may partially overlap the gate and/or source lines 510 and 520 by a predetermined distance.

Referring to FIG. 13E, the linearly patterned openings 542a, 544a and 546a that are arranged in the radial direction are then formed on the first, second and third sub electrodes 542, 544 and 546 of the pixel electrode member 540.

The number of the linearly patterned openings 542a, 544a and 546a on each of the first, second and third sub electrodes 542, 544 and 546 is sixteen. The linearly patterned openings 542a, 544a and 546a form a distorted electric field to form the multi-domain. In addition, the first, second and third protruding electrode portions 542b, 544b and 546b also form a distorted electric field to form the multi-domain. The linearly patterned openings 542a, 544a and 546a are formed through the patterning process for forming the pixel electrode member 540. Alternatively, the linearly patterned openings 542a, 544a and 546a may be formed through different patterning process from the forming of the pixel electrode member 540.

Referring to FIG. 13F, the insulating interlayer 534 shown in FIG. 11 is formed on the pixel electrode member 540, and the reflecting layer 550 is then formed on the pixel electrode member 540 to cover the first connecting electrode 541 and the first sub electrode 542.

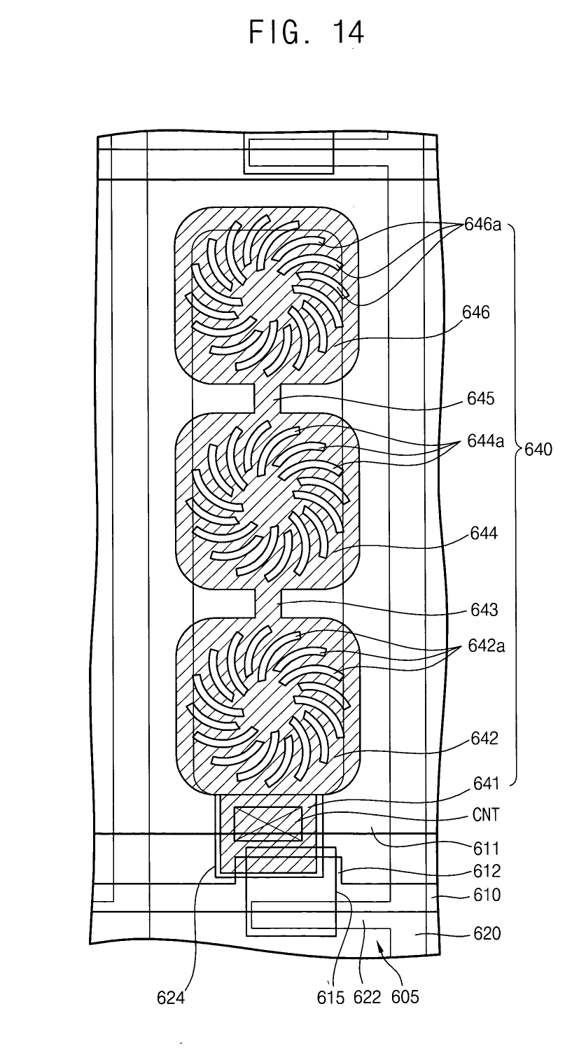

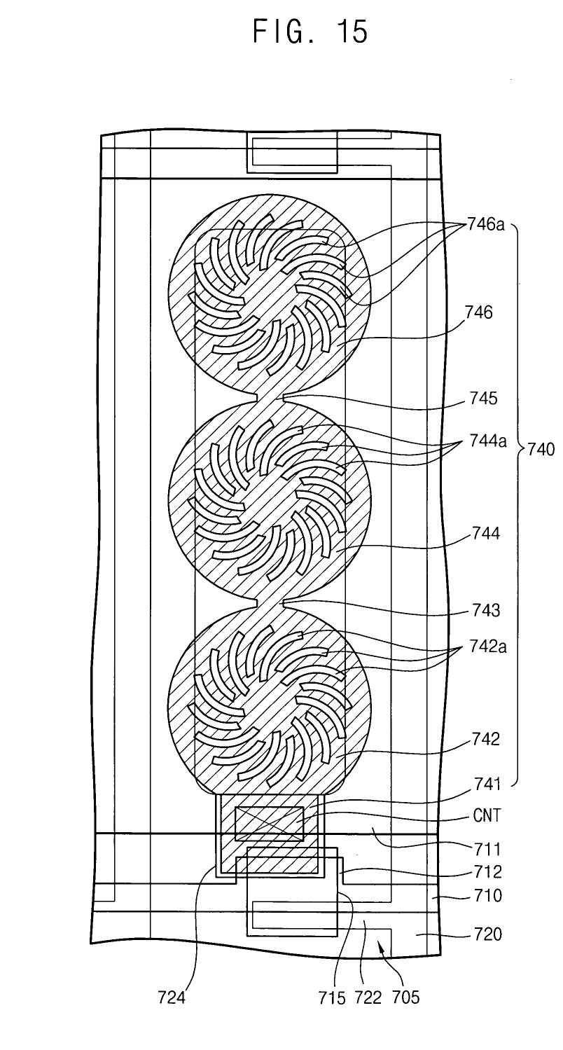

FIG. 14 is a plan view showing an array substrate in accordance with another embodiment of the present invention. The array substrate of FIG. 14 is the same as in FIGS. 1 to 2 except the shapes of the patterned openings. In FIG. 14, the patterned openings are curvilinear and arranged in a whirlpool pattern.

Referring to FIG. 14, the array substrate includes a second transparent substrate 605, a plurality of gate lines 610, a plurality of gate electrodes 612, a lower storage pattern 611 and a gate insulating layer 613. The gate lines 610 are on the second transparent substrate 605 extending in a first direction as shown in FIG. 14. The gate electrodes 612 are electrically connected to the gate lines 610. Each of the lower storage patterns 611 is spaced apart from each of the gate lines 610 in each of unit pixel regions. The gate insulating layer 613 includes an insulating material to cover the gate lines 610 and the gate electrodes 612.

The array substrate 600 may further include a semiconductor layer, an ohmic contact layer 615, a plurality of source lines 620, a plurality of source electrodes 622 and a plurality of drain electrodes 624. The semiconductor layer 614 is on the gate insulating layer 613 above each of the gate electrodes 612. The ohmic contact layer 615 is on the semiconductor layer 614. The source lines 620 extend in a second direction that is substantially perpendicular to the first direction. The unit pixel regions are defined by adjacent gate and source lines 610 and 620. The source electrodes 622 are electrically connected to the source lines 620. Each of the drain electrodes 624 is spaced apart from each of the source electrodes 622. Each of the gate electrodes 612, the semiconductor layer 614, the ohmic contact layer 615, each of the source electrodes 622 and each of the drain electrodes 624 form a thin film transistor (TFT).

The array substrate may further include a pixel electrode member 640 that is electrically connected to the drain electrode 624 of the TFT through the contact hole CNT. The pixel electrode member 640 has a plurality of patterned openings that are arranged in various directions. The pixel electrode member 640 partially overlaps the lower storage pattern 611 to define a capacitance of a storage capacitor Cst.

In particular, the pixel electrode member 640 includes a first connecting electrode 641, a first sub electrode 642, a second connecting electrode 643, a second sub electrode 644, a third connecting electrode 645 and a third sub electrode 646. The first connecting electrode 641 is electrically connected to the drain electrode 624 of the TFT. The first sub electrode 642 is electrically connected to the first connecting electrode 641, and has a quadrangular shape with rounded corners. The second connecting electrode 643 is electrically connected to the first sub electrode 642, and has a smaller width than the first sub electrode 642. The second sub electrode 644 is electrically connected to the second connecting electrode 643, and has a quadrangular shape with rounded corners. The third connecting electrode 645 is electrically connected to the second sub electrode 644, and has a smaller width than the second sub electrode 644. The third sub electrode 646 is electrically connected to the third connecting electrode 645, and has a quadrangular shape with rounded corners.

Each of the first, second and third sub electrodes 642, 644 and 646 has a plurality of curvilinearly patterned openings 642a, 644a and 646a that are arranged in a radial direction (e.g., forming a whirlpool pattern) with respect to a center of each of the first, second and third sub electrodes 642, 644 and 646. In the array substrate in FIG. 14, each of the first, second and third sub electrodes 642, 644 and 646 has sixteen curvilinearly patterned openings.

Sixteen domains are formed on each of the first, second and third sub electrodes 642, 644 and 646, allowing the rubbing process and the alignment layer to be omitted.

FIG. 15 is a plan view showing an array substrate in accordance with another embodiment of the present invention. The array substrate of FIG. 15 is similar to the embodiment in FIGS. 1 to 2 except for a pixel electrode member. In FIG. 15, the patterned openings are arranged on sub electrodes having a circular shape, and have a whirlpool shape.

Referring to FIG. 15, the array substrate includes a second transparent substrate 705, a plurality of gate lines 710, a plurality of gate electrodes 712, a lower storage pattern 711 and a gate insulating layer 713. The gate lines 710 are on the second transparent substrate 705 extending in a first direction, as shown. The gate electrodes 712 are electrically connected to the gate lines 710. Each of the lower storage patterns 711 is spaced apart from each of the gate lines 710 in each of unit pixel regions. The gate insulating layer 713 includes an insulating material to cover the gate lines 710 and the gate electrodes 712.

The array substrate 700 may further include a semiconductor layer, an ohmic contact layer 715, a plurality of source lines 720, a plurality of source electrodes 722 and a plurality of drain electrodes 724. The semiconductor layer 714 is on the gate insulating layer 713 corresponding to each of the gate electrodes 712. The ohmic contact layer 715 is on the semiconductor layer 714. The source lines 720 extend in a second direction that is substantially perpendicular to the first direction. The unit pixel regions are defined by adjacent gate and source lines 710 and 720. The source electrodes 722 are electrically connected to the source lines 720. Each of the drain electrodes 724 is spaced apart from each of the source electrodes 722. Each of the gate electrodes 712, the semiconductor layer 714, the ohmic contact layer 715, each of the source electrodes 722 and each of the drain electrodes 724 form a thin film transistor (TFT).

The array substrate may further include the pixel electrode member 740 that is electrically connected to the drain electrode 724 of the TFT through the contact hole CNT. The pixel electrode member 740 has a plurality of patterned openings that are arranged in various directions. The pixel electrode member 740 partially overlaps the lower storage pattern 711 to define a capacitance of a storage capacitor Cst.

In particular, the pixel electrode member 740 includes a first connecting electrode 741, a first sub electrode 742, a second connecting electrode 743, a second sub electrode 744, a third connecting electrode 745 and a third sub electrode 746. The first connecting electrode 741 is electrically connected to the drain electrode 724 of the TFT. The first sub electrode 742 is electrically connected to the first connecting electrode 741, and has a circular shape. The second connecting electrode 743 is electrically connected to the first sub electrode 742, and has a smaller width than the first sub electrode 742. The second sub electrode 744 is electrically connected to the second connecting electrode 743, and has a circular shape. The third connecting electrode 745 is electrically connected to the second sub electrode 744, and has a smaller width than the second sub electrode 744. The third sub electrode 746 is electrically connected to the third connecting electrode 745, and has a circular shape.

Each of the first, second and third sub electrodes 742, 744 and 746 has a plurality of curvilinearly patterned openings 742a, 744a and 746a that are arranged in a radial direction with respect to a center of each of the first, second and third sub electrodes 742, 744 and 746. In the array substrate in FIG. 15, each of the first, second and third sub electrodes 742, 744 and 746 has sixteen curvilinearly patterned openings.

Sixteen domains formed on each of the first, second and third sub electrodes 742, 744 and 746 allows the rubbing process and the alignment layer to be omitted.

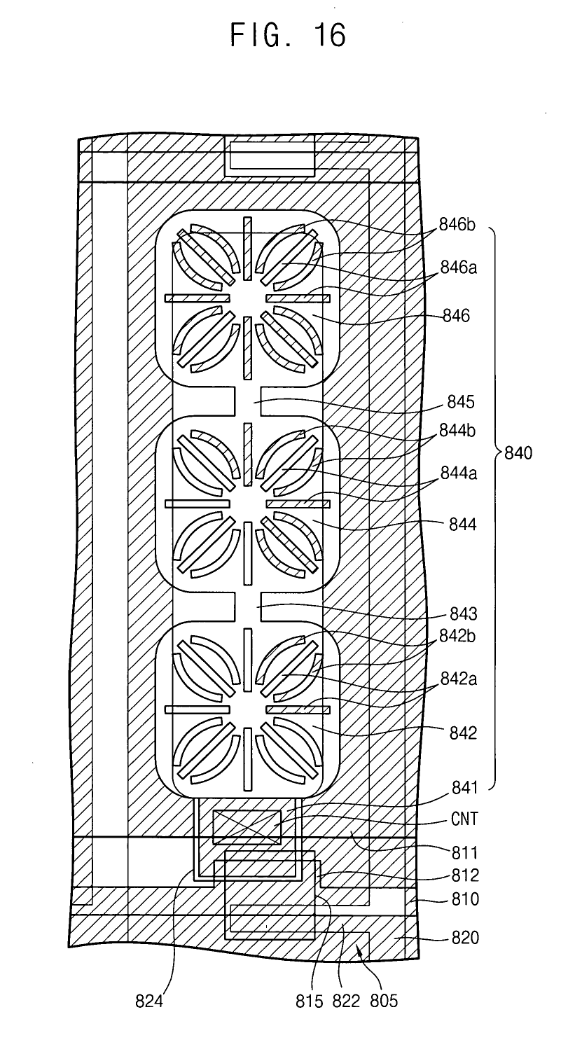

FIG. 16 is a plan view showing an array substrate in accordance with another embodiment of the present invention. The array substrate of FIG. 16 is similar to the embodiment in FIGS. 1 to 2 except for the pixel electrode member. In FIG. 16, patterned openings include a combination of linear shapes and curvilinear shapes.

Referring to FIG. 16, the array substrate includes a second transparent substrate 805, a plurality of gate lines 810, a plurality of gate electrodes 812, a lower storage pattern 811 and a gate insulating layer 813. The gate lines 810 are on the second transparent substrate 805 and extend in a first direction. The gate electrodes 812 are electrically connected to the gate lines 810. Each of the lower storage patterns 811 is spaced apart from each of the gate lines 810 in each of unit pixel regions. The gate insulating layer 813 includes an insulating material to cover the gate lines 810 and the gate electrodes 812.

The array substrate may further include a semiconductor layer, an ohmic contact layer 815, a plurality of source lines 820, a plurality of source electrodes 822 and a plurality of drain electrodes 824. The semiconductor layer 814 is on the gate insulating layer 813 corresponding to each of the gate electrodes 812. The ohmic contact layer 815 is on the semiconductor layer 814. The source lines 820 extend in a second direction that is substantially perpendicular to the first direction. The unit pixel regions are defined by adjacent gate and source lines 810 and 820. The source electrodes 822 are electrically connected to the source lines 820. Each of the drain electrodes 824 is spaced apart from each of the source electrodes 822. Each of the gate electrodes 812, the semiconductor layer 814, the ohmic contact layer 815, each of the source electrodes 822 and each of the drain electrodes 824 form a thin film transistor (TFT).

The array substrate may further include the pixel electrode member 840 that is electrically connected to the drain electrode 824 of the TFT through the contact hole CNT. The pixel electrode member 840 has a plurality of patterned openings that are arranged in various directions. The pixel electrode member 840 partially overlaps the lower storage pattern 811 to define the capacitance of a storage capacitor Cst.

In particular, the pixel electrode member 840 includes a first connecting electrode 841, a first sub electrode 842, a second connecting electrode 843, a second sub electrode 844, a third connecting electrode 845 and a third sub electrode 846. The first connecting electrode 841 is electrically connected to the drain electrode 824 of the TFT. The first sub electrode 842 is electrically connected to the first connecting electrode 841, and has a quadrangular shape with rounded corners. The second connecting electrode 843 is electrically connected to the first sub electrode 842, and has a smaller width than the first sub electrode 842. The second sub electrode 844 is electrically connected to the second connecting electrode 843, and has a quadrangular shape with rounded corners. The third connecting electrode 845 is electrically connected to the second sub electrode 844, and has a smaller width than the second sub electrode 844. The third sub electrode 846 is electrically connected to the third connecting electrode 845, and has a quadrangular shape with rounded corners.

Each of the first, second and third sub electrodes 842, 844 and 846 has a plurality of linearly patterned openings 842a, 844a and 846a and a plurality of curvilinearly patterned openings 842b, 844b and 846b that are arranged in a radial direction. In the array substrate in FIG. 16, each of the first, second and third sub electrodes 842, 844 and 846 has eight linearly patterned openings and eight curvilinearly patterned openings.

Sixteen domains formed on each of the first, second and third sub electrodes 842, 844 and 846 makes the rubbing process and the alignment layer to be omitted.

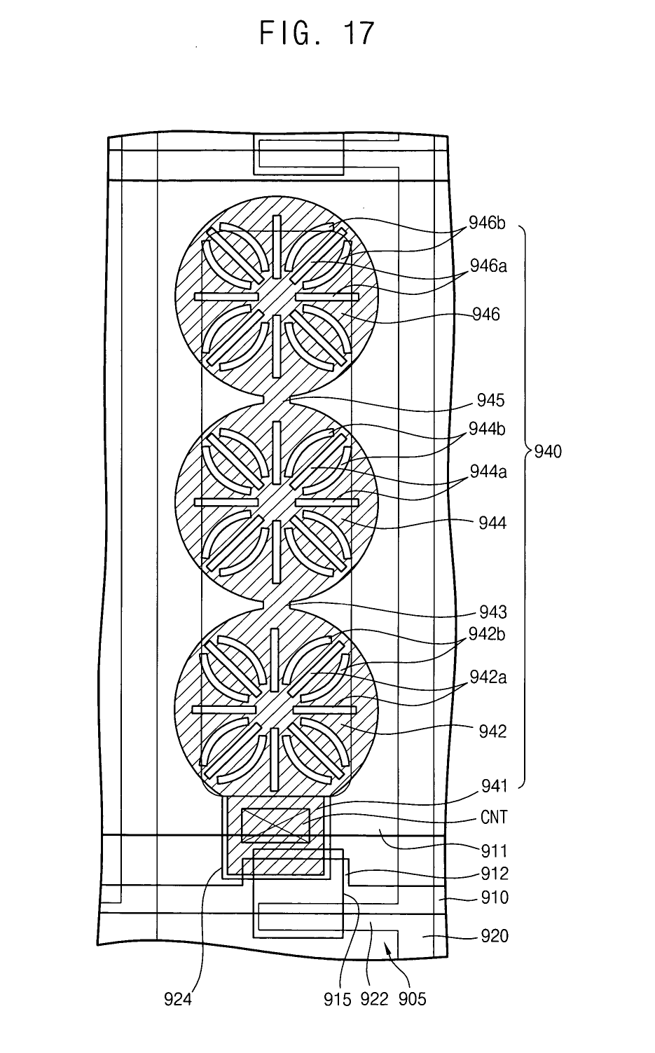

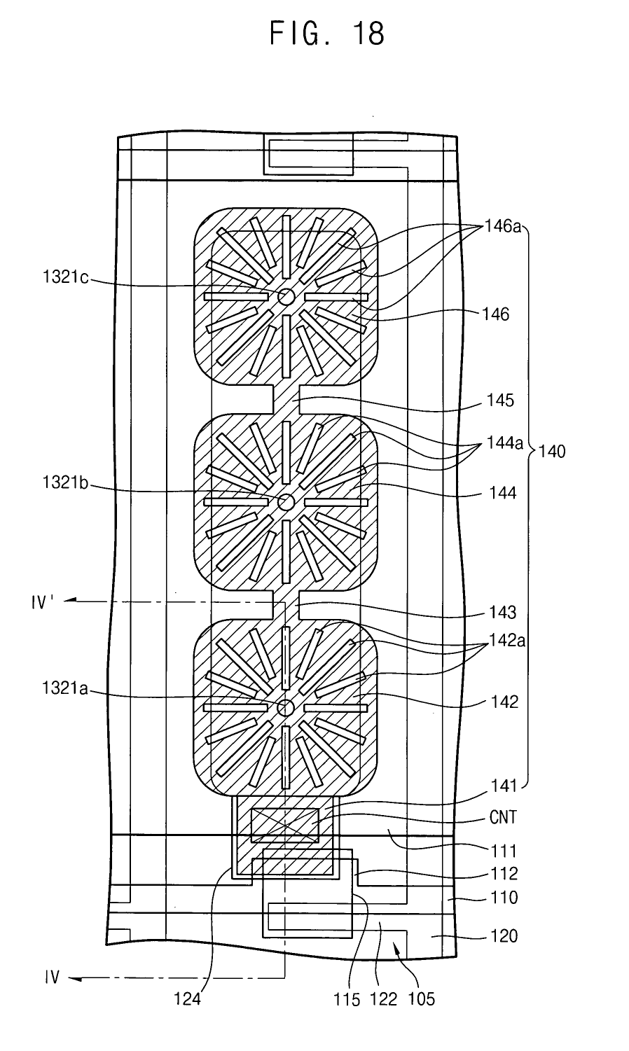

FIG. 17 is a plan view showing an array substrate in accordance with another embodiment of the present invention. The array substrate of FIG. 17 is similar to the embodiment in FIGS. 1 to 2 except for a pixel electrode member. In FIG. 17, the patterned openings are arranged on sub electrodes having a circular shape, and are a combination of linear shapes and curvilinear shapes.

Referring to FIG. 17, the array substrate includes a second transparent substrate 905, a plurality of gate lines 910, a plurality of gate electrodes 912, a lower storage pattern 911 and a gate insulating layer 913. The gate lines 910 are on the second transparent substrate 905 and extend in a first direction as shown in FIG. 17. The gate electrodes 912 are electrically connected to the gate lines 910. Each of the lower storage patterns 911 is spaced apart from each of the gate lines 910 in each of unit pixel regions. The gate insulating layer 913 includes an insulating material to cover the gate lines 910 and the gate electrodes 912.

The array substrate may further include a semiconductor layer, an ohmic contact layer 915, a plurality of source lines 920, a plurality of source electrodes 922 and a plurality of drain electrodes 924. The semiconductor layer 914 is on the gate insulating layer 913 corresponding to each of the gate electrodes 912. The ohmic contact layer 915 is on the semiconductor layer 914. The source lines 920 are extended in a second direction that is substantially perpendicular to the first direction. The unit pixel regions are defined by adjacent gate and source lines 910 and 920. The source electrodes 922 are electrically connected to the source lines 920. Each of the drain electrodes 924 are spaced apart from each of the source electrodes 922. Each of the gate electrodes 912, the semiconductor layer 914, the ohmic contact layer 915, each of the source electrodes 922 and each of the drain electrodes 924 form a thin film transistor (TFT).

The array substrate 900 may further include the pixel electrode member 940 that is electrically connected to the drain electrode 924 of the TFT through the contact hole CNT. The pixel electrode member 940 has a plurality of patterned openings that are arranged in various directions. The pixel electrode member 940 is partially overlapped with the lower storage pattern 911 to define a capacitance of a storage capacitor Cst.

In particular, the pixel electrode member 940 includes a first connecting electrode 941, a first sub electrode 942, a second connecting electrode 943, a second sub electrode 944, a third connecting electrode 945 and a third sub electrode 946. The first connecting electrode 941 is electrically connected to the drain electrode 924 of the TFT. The first sub electrode 942 is electrically connected to the first connecting electrode 941, and has a circular shape. The second connecting electrode 943 is electrically connected to the first sub electrode 942, and has a smaller width than the first sub electrode 942. The second sub electrode 944 is electrically connected to the second connecting electrode 943, and has a circular shape. The third connecting electrode 945 is electrically connected to the second sub electrode 944, and has a smaller width than the second sub electrode 944. The third sub electrode 946 is electrically connected to the third connecting electrode 945, and has a circular shape.

Each of the first, second and third sub electrodes 942, 944 and 946 has a plurality of linearly patterned openings 942a, 944a and 946a and a plurality of curvilinearly patterned openings 942b, 944b and 946b that are arranged in a radial direction with respect to a center of each of the first, second and third sub electrodes 942, 944 and 946. In the array substrate in FIG. 17, each of the first, second and third sub electrodes 942, 944 and 946 has eight linearly patterned openings and eight curvilinearly patterned openings, and the linearly patterned openings 942a, 944a and 946a and the curvilinearly patterned openings 942b, 944b and 946b are arranged in an alternating manner.

Sixteen domains are formed on each of the first, second and third sub electrodes 942, 944 and 946.

Therefore, the rubbing process and the alignment layer that is often placed on the array substrate or a color filter substrate may be omitted.

In FIGS. 1 to 17, the patterned openings are formed on the pixel electrode member of the array substrate to form the multiple domains.

Alternatively, the patterned openings may be formed on the color filter substrate, and the protrusion may be formed on the array substrate.

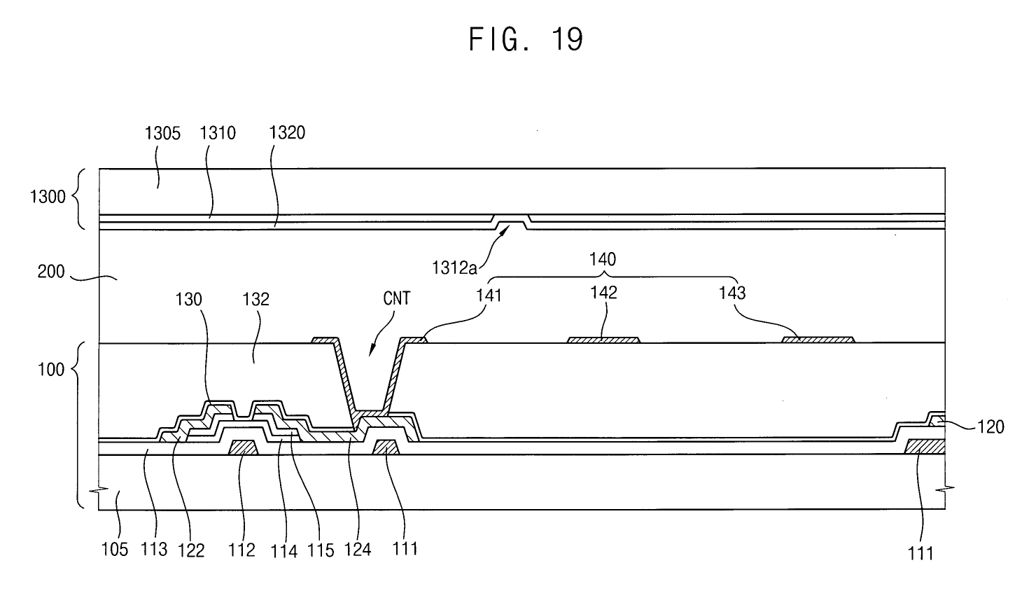

FIG. 18 is a plan view showing an LCD device in accordance with another embodiment of the present invention. FIG. 19 is a cross-sectional view taken along a line IV-IV′ shown in FIG. 18. In particular, the array substrate of the LCD device includes a plurality of patterned openings, and the color filter substrate of the LCD device includes a recess. In FIG. 18, the LCD device has a transmissive-type array substrate.

Referring to FIGS. 18 and 19, the LCD device includes an array substrate 100, a liquid crystal layer 200 and a color filter substrate 1300. The color filter substrate 1300 is combined with the array substrate 100 so that the liquid crystal layer 200 is interposed between the color filter substrate 1300 and the array substrate 100. The array substrate of FIGS. 18 and 19 is similar to that in FIGS. 1 and 2. Thus, the same reference numerals will be used to refer to the same or like parts as those described in FIGS. 1 and 2 and any further explanation concerning the above elements will be omitted.

The color filter substrate 1300 includes a first transparent substrate 1305, a color filter layer 1310 on the first transparent substrate 1305 and a common electrode member 1320 on the color filter layer 1310. The color filter substrate 1300 is combined with the array substrate 100 so that the liquid crystal layer 200 is interposed between the color filter substrate 1300 and the array substrate 100. In the LCD device in FIGS. 18 and 19, the liquid crystal layer 200 has a vertical alignment (VA) mode.

The color filter layer 1310 has a first hole 1312a, a second hole 1312b and a third hole 1312c. The first, second and third holes 1312a, 1312b and 1312c correspond to central portions of first, second and third sub electrodes 142, 144 and 146, respectively.

The common electrode member 1320 is on the color filter layer 1310 to cover the color filter layer 1310 along the first, second and third holes 1312a, 1312b and 1312c. Recesses are formed on the common electrode member 1320 where the first, second and third holes 1312a, 1312b and 1312c are located because the thickness of the common electrode member 1320 is substantially constant whether it is placed over a hole or not. The recesses of the common electrode member 1320 form a distorted electric field to form a multi-domain having a plurality of domains.

Sixteen domains are formed on each of the first, second and third sub electrodes 142, 144 and 146, and the recesses are formed on the central portions of each of the first, second and third sub electrodes 142, 144 and 146. Therefore, as explained above, the rubbing process and the alignment layer may be omitted.

According to the LCD device in FIGS. 18 and 19, the array substrate includes the pixel electrode member having the three sub electrodes, wherein each of the sub electrodes includes the patterned openings arranged in a radial direction with respect to a center of each of the sub electrodes. The common electrode member has the recesses corresponding to the central portions of the sub electrodes. Therefore, the liquid crystal layer 200 on the pixel electrode member has multiple domains.

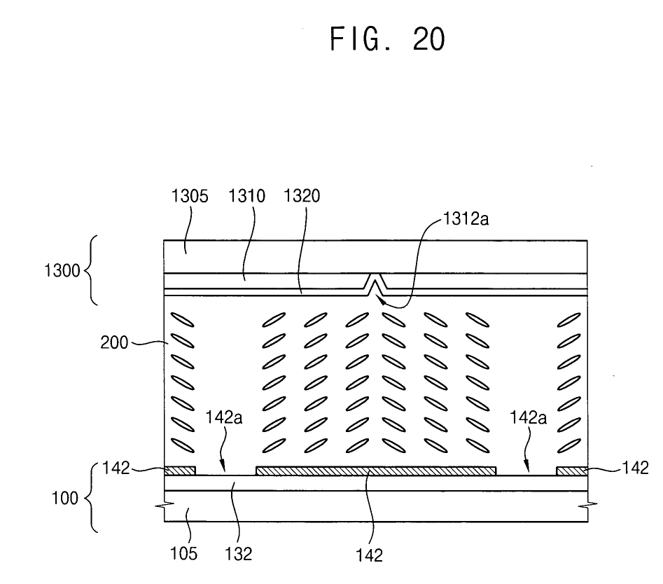

FIG. 20 is a cross-sectional view showing an operation of the LCD device shown in FIG. 18.

Referring to FIG. 20, when a voltage is applied to the pixel electrode member 140 shown in FIG. 18 and the common electrode member 1320, an electric field adjacent to the patterned openings 142a and the recesses 1312a is distorted so that an arrangement of liquid crystals in the liquid crystal layer 200 is changed. The long axes of the liquid crystals are aligned toward the patterned openings 142a and the recesses 1312a. That is, when the voltage is applied to the pixel electrode member 140 shown in FIG. 18 and the common electrode member 1320, the liquid crystals are inclined with respect to an electric field formed by the common electrode member 1320 and the pixel electrode member 140 shown in FIG. 18.

The multiple domains are thus formed by the patterned openings 142a of the array substrate 100 and the recesses 1312a of the color filter substrate 1300.

In some embodiments, the LCD device may further include at least one reflecting layer (not shown) that covers at least one sub electrode. The resulting LCD device would be able to operate in the reflective-transmissive mode.

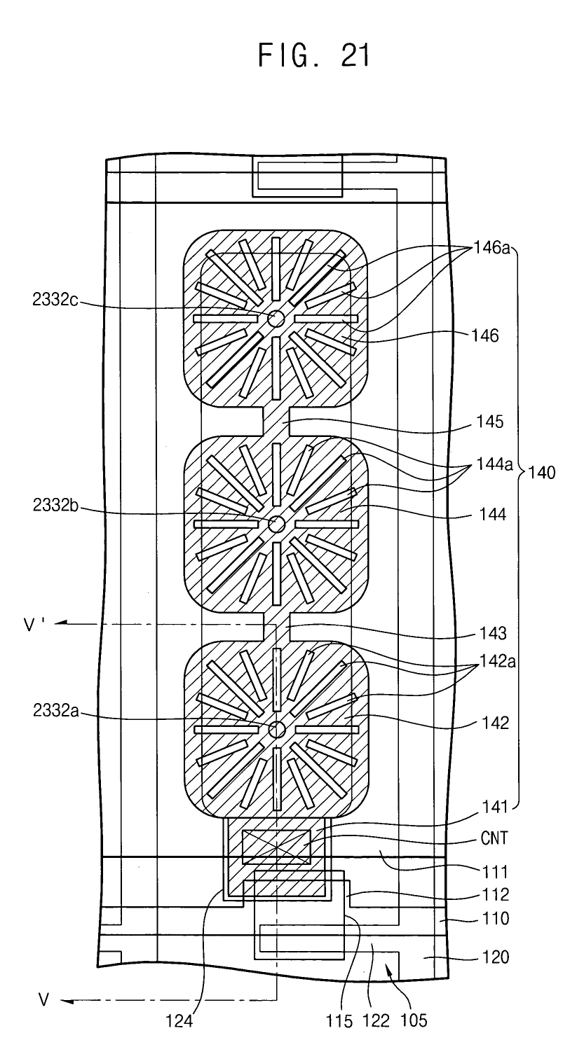

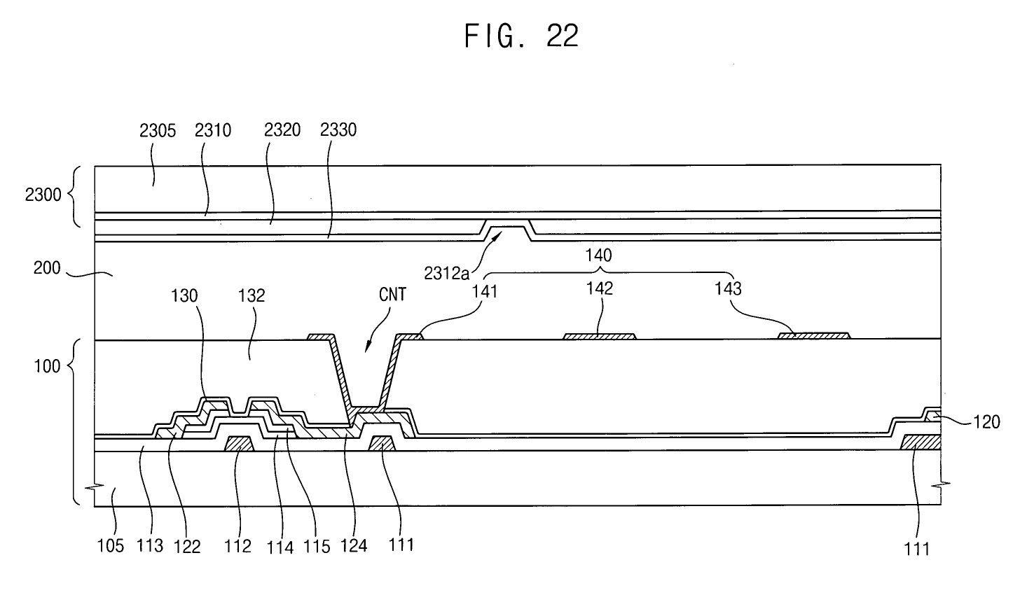

FIG. 21 is a plan view showing an LCD device in accordance with another embodiment of the present invention. FIG. 22 is a cross-sectional view taken along a line V-V′ shown in FIG. 21. The LCD device of FIGS. 21 and 22 is similar to the embodiment in FIGS. 18 to 19 except a color filter layer and an overcoating layer. Thus, the same reference numerals will be used to refer to the same or like parts as those described in FIGS. 18 and 19 and any further explanation concerning the above elements will be omitted. In FIGS. 21 and 22, the LCD device has a transmissive-type array substrate.

Referring to FIGS. 21 and 22, the LCD device includes an array substrate 100, a liquid crystal layer 200 and a color filter substrate 2300. The color filter substrate 2300 is combined with the array substrate 100 so that the liquid crystal layer 200 is interposed between the color filter substrate 2300 and the array substrate 100. The array substrate of FIGS. 21 and 22 is similar to that in FIGS. 1 and 2. Thus, the same reference numerals will be used to refer to the same or like parts as those described in FIGS. 1 and 2 and any further explanation concerning the above elements will be omitted.

The color filter substrate 2300 includes a first transparent substrate 2305, a color filter layer 2310 on the first transparent substrate 2305, an overcoating layer 2320 on the color filter layer 2310 and a common electrode member 2330 on the overcoating layer 2320. The color filter substrate 2300 is combined with the array substrate 100 so that the liquid crystal layer 200 is interposed between the color filter substrate 2300 and the array substrate 100. In the LCD device in FIGS. 21 and 22, the liquid crystal layer 200 has a vertical alignment (VA) mode.

The overcoating layer 2320 has a first hole 2332a, a second hole 2332b and a third hole 2332c. Alternatively, the overcoating layer 2320 may have first, second and third recesses that have depths smaller than thickness of the overcoating layer 2320. The first, second and third holes 2332a, 2332b and 2332c correspond to central portions of first, second and third sub electrodes 142, 144 and 146, respectively.

A common electrode member 2330 is on the overcoating layer 2320 to cover the color filter layer 2310 along the first, second and third holes 2332a, 2332b and 2332c so that recesses are formed on the common electrode member 2330 corresponding to the first, second and third holes 2332a, 2332b and 2332c. The recesses of the common electrode m ember 2330 form a distorted electric field to form multiple domains.

Sixteen domains are formed on each of the first, second and third sub electrodes 142, 144 and 146, and the recesses are formed on the central portions of each of the first, second and third sub electrodes 142, 144 and 146. Therefore, the rubbing process and the alignment layer may be omitted.

According to the LCD device in FIGS. 21 and 22, the thickness of the overcoating layer 2320 is adjusted according to the desired depth of the recesses of the common electrode member 2330, thereby improving a color reproducibility of the LCD device. A stepped portion of the overcoating layer 2320 may be formed by adjusting the exposure amount against a photoresist for while forming the overcoating layer 2320.

In addition, the array substrate includes the pixel electrode member having the three sub electrodes, wherein each of the sub electrodes includes the patterned openings extending in a radial direction from an area near the center of each of the sub electrodes. The common electrode member 2330 has recesses corresponding to the central portions of the sub electrodes. Therefore, the liquid crystal layer 200 on the pixel electrode member has multiple domains.

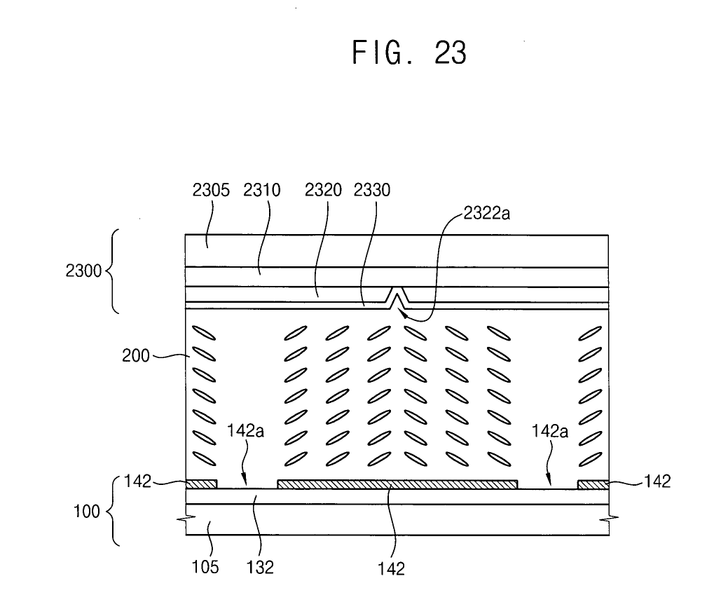

FIG. 23 is a cross-sectional view showing an operation of the LCD device shown in FIG. 21.

Referring to FIG. 23, when a voltage is applied to the pixel electrode member 140 shown in FIG. 21 and the common electrode member 2330, an electric field adjacent to the patterned openings 142a and the recesses 2332a is distorted so that an arrangement of liquid crystals in the liquid crystal layer 200 is changed. The long axes of the liquid crystals are aligned toward the patterned openings 142a and the recesses 2332a. That is, when the voltage is applied to the pixel electrode member 140 shown in FIG. 21 and the common electrode member 2330, the liquid crystals are inclined with respect to an electric field formed by the common electrode member 2330 and the pixel electrode member 140 shown in FIG. 21.

The multiple domains are formed by the patterned openings 142a of the array substrate 100 and the recesses 2332a of the color filter substrate 2300.

In other embodiments, the LCD device may further include at least one reflecting layer (not shown) that covers at least one sub electrode. In such case, the LCD device may be a reflective-transmissive LCD device.

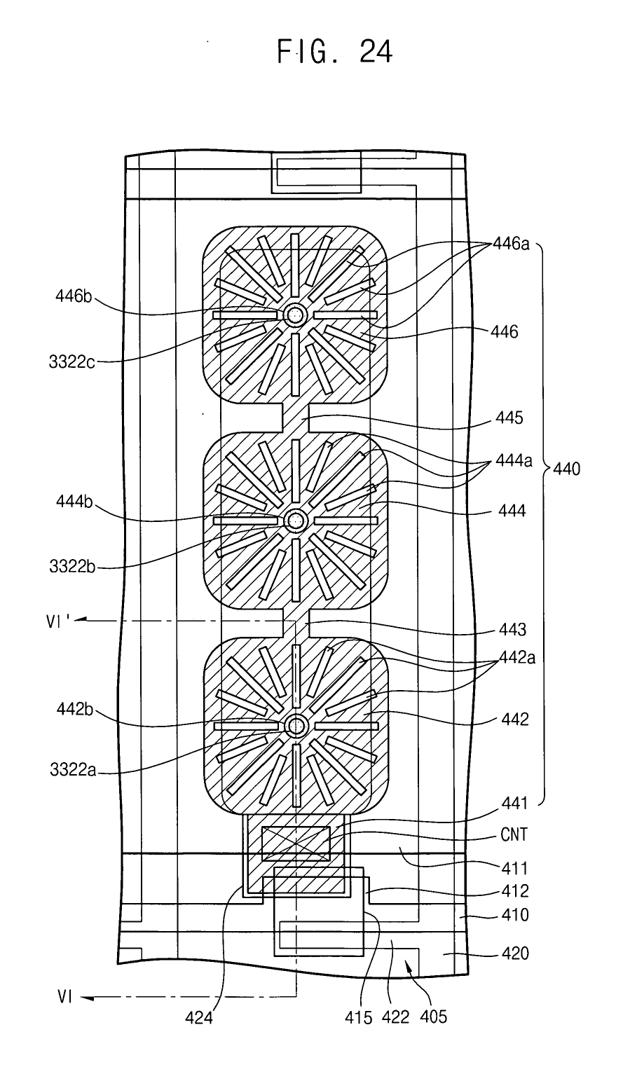

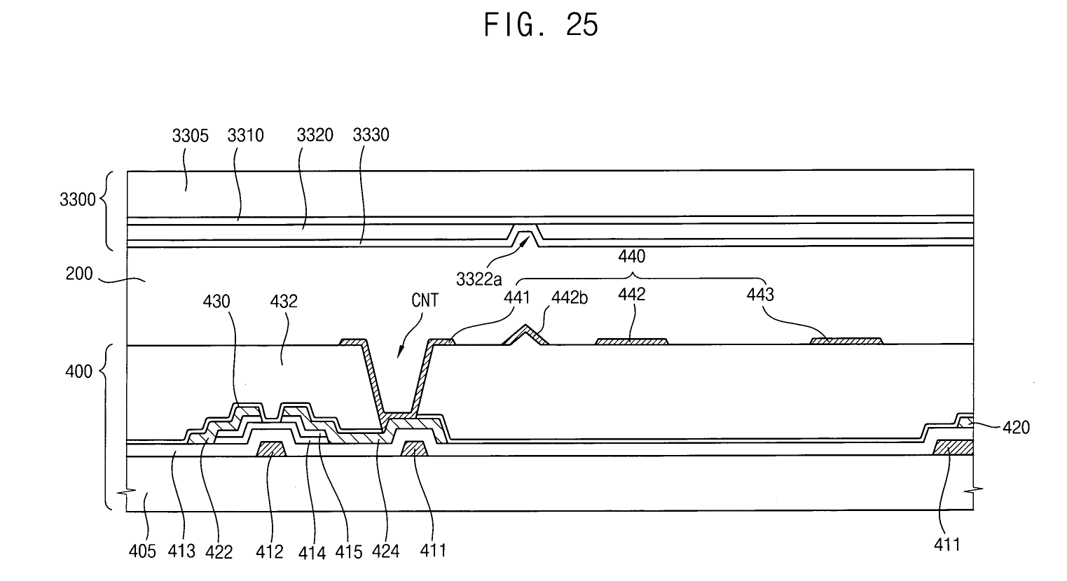

FIG. 24 is a plan view showing an LCD device in accordance with another embodiment of the present invention. FIG. 25 is a cross-sectional view taken along a line VI-VI′ shown in FIG. 24. The LCD device of FIGS. 24 and 25 is similar to the embodiment of FIGS. 21 to 22 except for the protrusions. In FIGS. 24 and 25, the LCD device has a transmissive-type array substrate.

Referring to FIGS. 24 and 25, the LCD device includes an array substrate 400, a liquid crystal layer 200 and a color filter substrate 3300. The color filter substrate 3300 is combined with the array substrate 400 so that the liquid crystal layer 200 is interposed between the color filter substrate 3300 and the array substrate 400. The array substrate of FIGS. 24 and 25 is similar to that in FIGS. 6 and 7. Thus, the same reference numerals will be used to refer to the same or like parts as those described in FIGS. 6 and 7 and any further explanation concerning the above elements will be omitted.

The color filter substrate 3300 includes a first transparent substrate 3305, a color filter layer 3310 on the first transparent substrate 3305, an electrically insulative overcoating layer 3320 on the color filter layer 3310 and a common electrode member 3330 on the overcoating layer 3320. The color filter substrate 3300 is combined with the array substrate 400 so that the liquid crystal layer 200 is interposed between the color filter substrate 3300 and the array substrate 400. In the LCD device in FIGS. 24 and 25, the liquid crystal layer 200 operates in the vertical alignment (VA) mode.

The overcoating layer 3320 has a first hole 3322a, a second hole 3322b and a third hole 3322c. In some embodiments, the overcoating layer 3320 may have first, second and third recesses that are thinner than the overcoating layer 3320. The first, second and third holes 3322a, 3322b and 3322c are aligned with the first, second and third protruding electrode portions 442b, 444b and 446b on the central portions of first, second and third sub electrodes 442, 444 and 446, respectively.

The common electrode member 3330 is on the overcoating layer 3320 to cover the color filter layer 3310 along the first, second and third holes 3322a, 3322b and 3322c so that recesses formed on the common electrode member 3330 are aligned with the first, second and third holes 3322a, 3322b and 3322c. The recesses of the common electrode member 3330 distort the electric field to form multiple domains.

Sixteen domains are formed on each of the first, second and third sub electrodes 442, 444 and 446, and the recesses are formed on the central portions of each of the first, second and third sub electrodes 442, 444 and 446. With the multiple domains, the rubbing process and the alignment layer may be omitted.

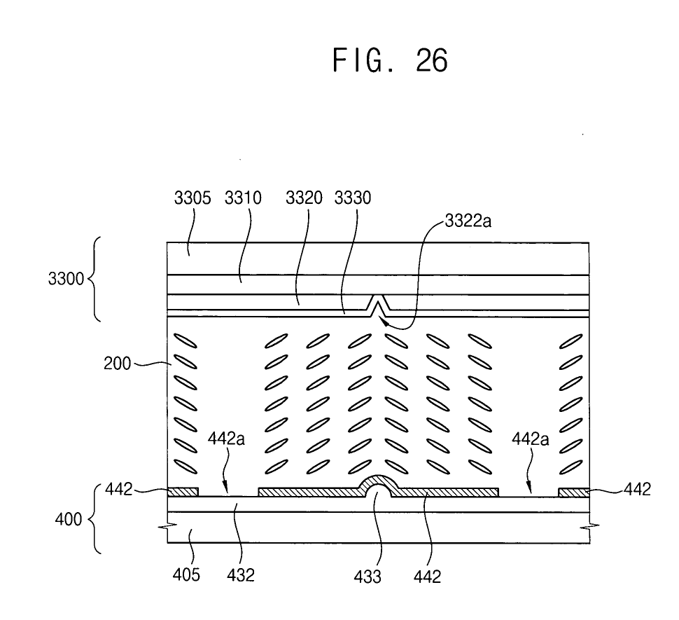

FIG. 26 is a cross-sectional view showing an operation of the LCD device shown in FIG. 24.

Referring to FIG. 26, when a voltage is applied to the pixel electrode member 440 shown in FIG. 24 and the common electrode member 3330, an electric field adjacent to the patterned openings 442a and the recesses 3322a is distorted so that an arrangement of liquid crystals in the liquid crystal layer 200 is changed. Long axes of the liquid crystals are aligned toward the patterned openings 442a and the recesses 3322a. That is, when the voltage is applied to the pixel electrode member 440 shown in FIG. 24 and the common electrode member 3330, the liquid crystals are inclined with respect to an electric field formed by the common electrode member 3330 and the pixel electrode member 440 shown in FIG. 24.

Multiple domains are formed by the patterned openings 442a and the protruding electrode portions 442b of the array substrate 400, and the recesses 3322a of the color filter substrate 3300.

Alternatively, the LCD device may further include at least one reflecting layer (not shown) that covers at least one sub electrode. That is, the LCD device may be a reflective-transmissive LCD device.

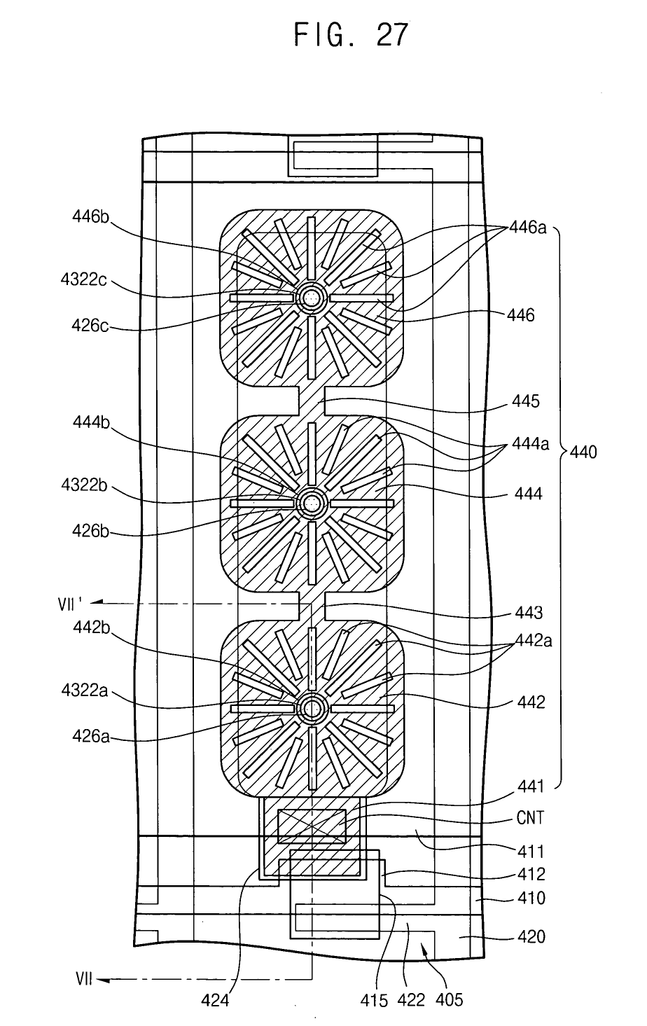

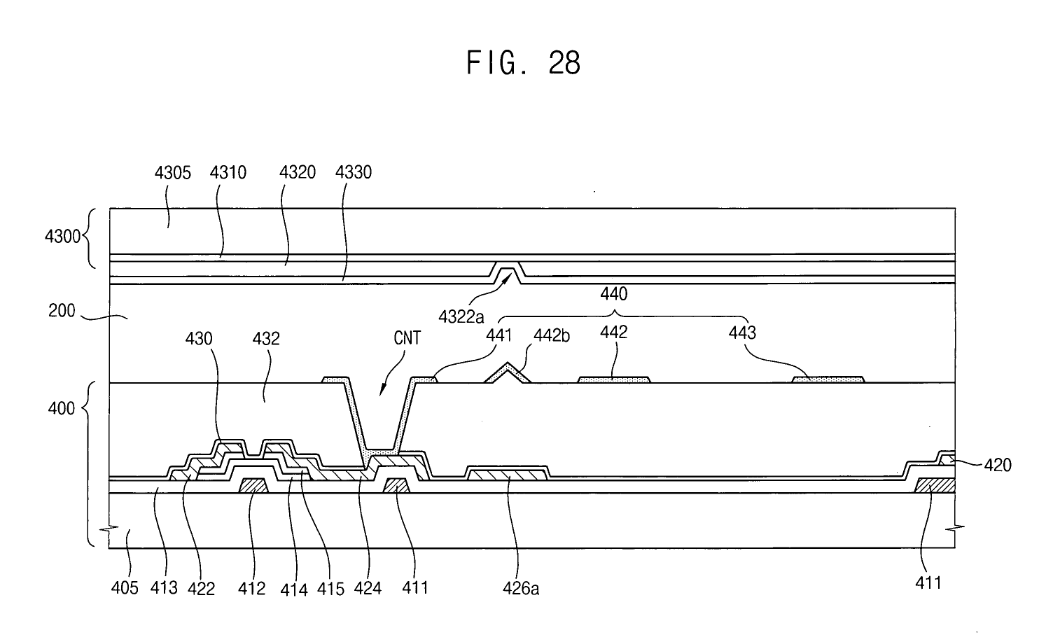

FIG. 27 is a plan view showing an LCD device in accordance with another embodiment of the present invention. FIG. 28 is a cross-sectional view taken along a line VII-VII′ shown in FIG. 27. The LCD device of FIGS. 27 and 28 is similar to the device in FIGS. 6, 7, 24, and 25 except for the blocking patterns. Thus, the same reference numerals will be used to refer to the same or like parts as those described in FIGS. 24 and 25 and any further explanation concerning the above elements will be omitted. In FIGS. 27 and 28, the LCD device has a transmissive-type array substrate.

Referring to FIGS. 27 and 28, the LCD device includes an array substrate 400, a liquid crystal layer 200 and a color filter substrate 4300. The color filter substrate 4300 is combined with the array substrate 400 so that the liquid crystal layer 200 is interposed between the color filter substrate 4300 and the array substrate 400.

The array substrate 400 may further include a first blocking pattern 426a, a second blocking pattern 426b and a third blocking pattern 426c. The first, second and third blocking patterns 426a, 426b and 426c are spaced apart from drain electrodes 424 of TFTs. The first, second and third blocking patterns 442b, 444b and 446b block light passing through a portion of the liquid crystal layer 200 corresponding to the first, second and third protruding electrode portions 442b, 444b and 446b, respectively. In FIGS. 27 and 28, the first, second and third blocking patterns 442b, 444b and 446b are formed from the same layer as the source lines 420. In some embodiments, however, the first, second and third blocking patterns 442b, 444b and 446b may be formed from a different layer from the source lines 420.

In FIGS. 27 and 28, the first, second and third blocking patterns 442b, 444b and 446b are smaller than the first, second and third protruding electrode portions 442b, 444b and 446b, respectively. When a reflecting layer (not shown) is formed on at least one of the first, second and third sub electrodes 442, 444 and 446, the first, second and third blocking patterns 442b, 444b and 446b may be greater than the first, second and third protruding electrode portions 442b, 444b and 446b, respectively.

The color filter substrate 4300 includes a first transparent substrate 4305, a color filter layer 4310 on the first transparent substrate 4305, an overcoating layer 4320 on the color filter layer 4310 and a common electrode member 4320 on the overcoating layer 4310. The color filter substrate 4300 is combined with the array substrate 400 so that the liquid crystal layer 200 is interposed between the color filter substrate 4300 and the array substrate 400. The LCD device in FIGS. 27 and 28, the liquid crystal layer 200 has a vertical alignment (VA) mode.

The overcoating layer 4320 has a first hole 4322a, a second hole 4322b and a third hole 4322c. Alternatively, the overcoating layer 4320 may have first, second and third recesses that are thinner than the overcoating layer 4320. The first, second and third holes 4322a, 4322b and 4322c correspond to first, second and third protruding electrode portions 442b, 444b and 446b on central portions of first, second and third sub electrodes 442, 444 and 446, respectively.

The common electrode member 4330 is on the overcoating layer 4320 to cover the color filter layer 4310 along the first, second and third holes 4322a, 4322b and 4322c so that recesses are formed on the common electrode member 4330 corresponding to the first, second and third holes 4322a, 4322b and 4322c. The recesses of the common electrode member 4330 form a distorted electric field, forming multiple domains.

Sixteen domains are formed on each of the first, second and third sub electrodes 442, 444 and 446, and the recesses are formed on the central portions of each of the first, second and third sub electrodes 442, 444 and 446. Therefore, the rubbing process and the alignment layer may be omitted.

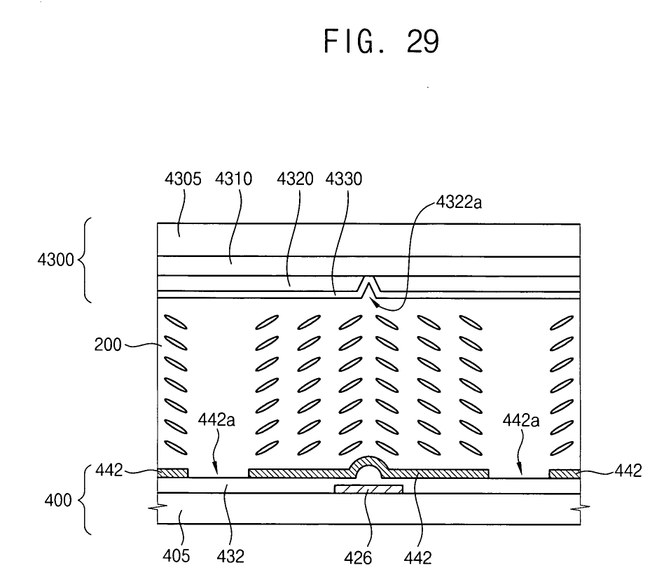

FIG. 29 is a cross-sectional view showing an operation of the LCD device shown in FIG. 27.

Referring to FIG. 29, when a voltage is applied to the pixel electrode member 440 shown in FIG. 27 and the common electrode member 4330, an electric field adjacent to the patterned openings 442a and the recesses 4322a is distorted so that an arrangement of liquid crystals in the liquid crystal layer 200 is changed. Long axes of the liquid crystals are aligned toward the patterned openings 442a and the recesses 4322a. That is, when the voltage is applied to the pixel electrode member 440 shown in FIG. 27 and the common electrode member 4330, the liquid crystals are inclined with respect to an electric field formed by the common electrode member 4330 and the pixel electrode member 440 shown in FIG. 27.

Multiple domains are formed by the patterned openings 442a and the protruding electrode portions 442b of the array substrate 400, and the recesses 4322a of the color filter substrate 4300. The blocking pattern 426 blocks light passing through a portion of the liquid crystal layer 200 corresponding to the protruding electrode portion, although the LCD device displays black.

In some embodiments, the LCD device may further include at least one reflecting layer (not shown) that covers at least one sub electrode. The resulting LCD device may operate in a reflective-transmissive mode.

According to the present invention, the pixel electrode member of the array substrate has the patterned openings that have the linear shape or the curvilinear shape in the whirlpool shape, thereby forming multiple domains.

In addition, the pixel electrode of the array substrate has the patterned openings, and the common electrode member of the color filter substrate has the recesses, thereby forming the plurality of domains. Furthermore, the blocking pattern is formed aligned with the protrusions to prevent the light leakage in the area adjacent to the protrusions.

Therefore, a viewing angle of the LCD device is increased to improve the image display quality.

Although exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. An array substrate comprising:
a substrate having a pixel region;
a switching element formed in the pixel region; and
a pixel electrode member electrically connected to the switching element, the pixel electrode member having a plurality of patterned openings that are extended in different directions from each other.

2. The array substrate of claim 1, wherein the pixel electrode member comprises:
a plurality of sub electrodes; and
a connecting electrode to electrically connect the sub electrodes adjacent to each other, the connecting electrode having a width greater than the sub electrodes.

3. The array substrate of claim 2, wherein the patterned openings have a linear shape and extend in a radial direction in each of the sub electrodes.

4. The array substrate of claim 2, wherein the patterned openings have a curvilinear shape and extend in a radial direction in each of the sub electrodes to form a whirlpool pattern.

5. The array substrate of claim 1, wherein the pixel electrode member comprises:
a plurality of sub electrodes;
a connecting electrode to electrically connect the sub electrodes adjacent to each other, the connecting electrode having a width greater than the sub electrodes; and
a reflecting portion formed on at least one of the sub electrodes so as to reflect light.

6. The array substrate of claim 5, wherein the sub electrode corresponding to the reflecting portion comprises a plurality of first portions having a convex shape and a plurality of second portions, and the first portions have a greater height than the second portions.

7. The array substrate of claim 5, wherein the reflecting portion is formed on the sub electrode that is electrically connected to the switching element.

8. The array substrate of claim 5, wherein each of the sub electrodes has a quadrangular shape, a quadrangular shape having rounded corners or a circular shape.

9. The array substrate of claim 1, wherein the pixel electrode member comprises a plurality of sub electrodes that are electrically connected to each other and have the patterned openings, and the patterned openings opposite to each other with respect to a center of each of the sub electrodes have substantially equal width.

10. The array substrate of claim 1, wherein the pixel electrode member further comprises a protrusion.

11. A method of manufacturing an array substrate, the method comprising:
forming a gate line, a source line and a switching element electrically connected to the gate and source lines in a unit pixel region of a substrate; and
forming a pixel electrode member electrically connected to the switching element, the pixel electrode member having a plurality of patterned openings that extend in different directions from each other so as to define a plurality of domains in the unit pixel region.

12. The method of claim 11, wherein the forming of the pixel electrode member further comprises:
forming an organic insulating layer on the substrate on which the gate line, the source line and the switching element are formed; and
forming a plurality of first portions having a convex shape and a plurality of second portions having a smaller height than the first portions on the organic insulating layer.

13. The method of claim 12, wherein the forming of the pixel electrode member further comprises forming a reflecting portion on the pixel electrode member.

14. The method of claim 11, wherein the pixel electrode member comprises:
a plurality of sub electrodes; and
a connecting electrode to electrically connect the sub electrodes adjacent to each other, the connecting electrode having a width greater than the sub electrodes.

15. A color filter substrate combined with an array substrate having a plurality of pixel electrodes and sandwiching a liquid crystal layer between the color filter substrate and the array substrate, the color filter substrate comprising:
a base substrate having a pixel region; and
a common electrode member formed on the base substrate, the common electrode member having a recess formed in the pixel region so as to form a plurality of domains in the liquid crystal layer corresponding to the pixel region.

16. The color filter substrate of claim 15, further comprising a color filter layer formed between the base substrate and the common electrode member, and the color filter layer having a hole that creates the recess upon formation of the common electrode member.

17. The color filter substrate of claim 15, further comprising a color filter layer formed between the base substrate and the common electrode member; and
an insulating layer to cover the color filter layer,
wherein the insulating layer has a hole corresponding to the recess of the common electrode member.

18. A display device comprising:
an upper substrate having a common electrode member;
a liquid crystal layer; and
a lower substrate combined with the upper substrate so that the liquid crystal layer is interposed between the upper and lower substrates, the lower substrate comprising a pixel electrode member facing the common electrode member, the pixel electrode member having a plurality of patterned openings that extend in directions different from each other so as to form a plurality of domains.

19. The display device of claim 18, wherein the lower substrate further comprises:
a gate line;
a data line; and
a switching element electrically connected to the gate line and data line, the switching element including a drain electrode electrically connected to the pixel electrode member.

20. The display device of claim 18, wherein the upper substrate further comprises a color filter layer, and the common electrode member is on the color filter layer to cover the color filter layer.

21. The display device of claim 20, wherein the common electrode member has a planar shape.

22. The display device of claim 18, wherein the pixel electrode member comprises:
a plurality of sub electrodes;
a connecting electrode to electrically connect the sub electrodes adjacent to each other, the connecting electrode having a width greater than the sub electrodes; and
a reflecting portion to reflect light, the reflecting portion being formed on at least one of the sub electrodes.

23. A display device comprising:
a liquid crystal layer;
an array substrate comprising a switching element formed in a pixel region and a pixel electrode electrically connected to the switching element, the pixel electrode member having a plurality of patterned openings that extend in directions different from each other; and
a color filter substrate comprising a common electrode member having a recess formed in the pixel region so as to form a plurality of domains in the liquid crystal layer corresponding to the pixel region.

24. The display device of claim 23, wherein an electric field generated by the recess of the common electrode member and the pixel electrode member form the domains in the liquid crystal layer in the pixel region.

25. The display device of claim 24, wherein the color filter substrate further comprises a color filter layer formed in the pixel region, and the common electrode member is on the color filter layer to cover the color filter layer.

26. The display device of claim 25, wherein the color filter layer has a hole that creates the recess upon formation of the common electrode member.

27. The display device of claim 25, wherein the color filter substrate further comprises an insulating layer to cover the color filter layer, and the insulating layer has a hole that creates the recess upon formation of the common electrode member.

28. The display device of claim 23, wherein the switching element comprises:
a gate electrode electrically connected to a gate line;
a source electrode electrically connected to a source line;
a drain electrode electrically connected to the pixel electrode member; and
a semiconductor layer between the source and drain electrodes.

29. The display device of claim 23, wherein the pixel electrode member comprises:
a plurality of sub electrodes; and
a connecting electrode to electrically connect the sub electrodes adjacent to each other, the connecting electrode having a width greater than the sub electrodes.

30. The display device of claim 29, wherein the patterned openings have a linear shape and are arranged in a radial direction with respect to a center of each of the sub electrodes.

31. The display device of claim 29, wherein the patterned openings have a curvilinear shape and are arranged in a radial direction with respect to a center of each of the sub electrodes to form a whirlpool pattern.

32. The display device of claim 23, wherein the pixel electrode member comprises:
a plurality of sub electrodes;
a connecting electrode to electrically connect the sub electrodes adjacent to each other, the connecting electrode having a width greater than the sub electrodes; and
a reflecting portion formed on at least one of the sub electrodes to reflect light.

33. The display device of claim 32, wherein the sub electrode corresponding to the reflecting portion comprises a plurality of first portions having a convex shape and a plurality of second portions having a smaller height than the first portions.

34. The display device of claim 32, wherein the reflecting portion is formed on at least one of the sub electrodes that are electrically connected to the switching element.

35. The display device of claim 32, wherein each of the sub electrodes has a quadrangular shape with rounded corners or a circular shape.

36. The display device of claim 32, wherein the pixel electrode member comprises a plurality of sub electrodes that are electrically connected to each other and have the patterned openings, and the patterned openings that are across a center of each of the sub electrodes from each other have substantially equal width.

37. The display device of claim 23, wherein the pixel electrode member further comprises a protrusion.

38. The display device of claim 37, wherein the color filter substrate further comprises a blocking pattern corresponding to the protrusion.

39. The display device of claim 38, wherein the blocking pattern comprises same material as a gate electrode of the switching element.

40. The display device of claim 38, wherein the blocking pattern comprises same material as a source electrode and a drain electrode of the switching element.

41. The display device of claim 37, wherein the protrusion is formed in a transmission region of the array substrate, and the recess is formed on the color filter substrate corresponding to a reflection region of the array substrate.
